(19) United States
(12) Patent Application Publication
(10) Pub. No.: US 2024/0298638 A1
(43) Pub. Date: Sep. 12, 2024

(54) METHODS AND COMPOSITIONS FOR REDUCING MICROBIAL CONTAMINANTS DURING POULTRY PROCESSING

(71) Applicant: DIVERSEY, INC., Fort Mill, SC (US)

(72) Inventors: Sarvesh D. Pingulkar, Mumbai (IN); Chintamani Mhaiskar, Thane (IN); Vishal J. Parekh, Mumbai (IN); David Limbaugh, Seattle, WA (US)

(21) Appl. No.: 18/036,511

(22) PCT Filed: Nov. 12, 2021
(86) PCT No.: PCT/US2021/059102

§ 371 Date: May 11, 2023

(30) Foreign Application Priority Data
Nov. 13, 2020 (IN) 202031049758
Nov. 13, 2020 (WO) PCT/US2021059102

(51) Int. Cl. A01N 37/16; A01N 25/02; A01N 37/02; A01N 37/10; A01N 37/36; A01N 43/08; A01P 1/00

(52) U.S. Cl. CPC A01N 37/16; A01N 25/02; A01N 37/02; A01N 37/10; A01N 37/36; A01N 43/08; A01P 1/00

(57) ABSTRACT

A method of reducing microbial contaminant comprises contacting the poultry, the surfaces used in processing poultry, or both with a synergistic antimicrobial composition during poultry processing. The method may provide an antimicrobial intervention that passes the FSIS antimicrobial reduction performance standards with nBPW as neutralizer, without any carry over after neutralization. In the first aspect, the synergistic antimicrobial composition comprises a peroxycarboxylic acid, a carboxylic acid, an anionic surfactant, and water. In the second aspect, a synergistic antimicrobial composition comprises a quaternary ammonium salt, a carboxylic acid, and water. In the third aspect, the synergistic antimicrobial comprises a quaternary ammonium salt, a peroxycarboxylic acid, and water.

### CROSS-REFERENCE TO RELATED APPLICATION

This application claims priority to Indian Provisional Application No. 202031049758, filed on Nov. 13, 2020.

### TECHNICAL FIELD

The present disclosure relates to the methods and the antimicrobial compositions for reducing microbial contaminants on poultry or on surfaces used for processing, during the poultry processing.

### BACKGROUND

Food safety is an important issue in the food industry, particularly in the industry of supplying protein (i.e., edible “meat” products) such as poultry. By the very nature of animals, the conditions in which they are grown to suitable size, and the nature of the commercial slaughtering processes, all meat carcasses entering the processing environment are contaminated with microorganisms such as Salmonella. Furthermore, once in the processing environment, a significant number of carcasses can become cross-contaminated with microorganisms during handling, scalding, and mechanical processing.

It has continued to be a challenge for the meat processing industry to produce meat that comply with governmental and industry standards, and are safe for consumption. The consequences of microbial contaminated meat can be serious in terms of public health, exposing many individuals to sickness and possibly death.

Chemical antimicrobial interventions have been commonly used for reducing the microbial contaminant during poultry processing. However, the chemical antimicrobial interventions have potential for carryover to the carcass when rinsed with buffered peptone water collected for monitoring microbial contaminants. Such carryover leads to false-negative results due to continuing bactericidal action of the antimicrobial chemicals in the rinse. To address the potential carryover problem, the United States Department of Agriculture, Food Safety and Inspection Service (FSIS) issued the Notice in 2016 that mandates the use of new neutralizing buffered peptone water (hereinafter referred as a “nBPW”), instead of the buffered peptone water (“BPW”), in determining the effectiveness of antimicrobial interventions on poultry. The use of nBPW as a neutralizer helps reduce false-negative results and provides more accurate determination of the effectiveness of antimicrobial interventions on poultry. As the nBPW neutralizer reduces the carryover antimicrobial activity, many known antimicrobial compositions show insufficient antimicrobial interventions under the FSIS antimicrobial reduction performance standards.

To comply with the FSIS antimicrobial reduction performance standards with nBPW as a neutralizer, the poultry processing industry often has to increase the usages of antimicrobial chemicals being applied during processing. Unfortunately, this may result in many undesirable consequences (e.g., discoloration, unpleasant odor and/or off-tastes of poultry) that are offensive or objectionable to potential purchasers and consumers. Furthermore, the increased usages of antimicrobial chemicals leads to a higher operating cost.

Accordingly, there is a significant industry and public need for an improved antimicrobial intervention for poultry processing with the nBPW neutralizer that can do so without adversely affecting the color, smell or taste of the poultry.

### SUMMARY

In the first aspect, a synergistic antimicrobial composition is provided that comprises a peroxycarboxylic acid in an amount of from about 0.006 wt % to about 0.20 wt % based on total weight of the composition, a carboxylic acid in an amount of from about 0.008 wt % to about 10 wt % based on total weight of the composition, an anionic surfactant, and water. The antimicrobial composition has a pH of no more than 7, and may comprise a pH adjusting acid. In some embodiments, the antimicrobial composition has a pH of less than 5. In certain embodiments, the antimicrobial composition has a pH of less than 3. In some embodiments, the peroxycarboxylic acid is present in an amount of from about 0.01 wt % to about 0.20 wt % based on total weight of the composition. In some embodiments, the carboxylic acid is present in an amount of from about 0.015 wt % to about 10 wt %, preferably from about 0.10 wt % to about 10 wt % based on total weight of the composition. In some embodiments, the antimicrobial composition comprises the anionic surfactant in an amount of from about 0.001 wt % to about 1.1 wt %. In certain embodiments, an amount of the anionic surfactant is from about 0.02 wt % to about 1 wt % based on total weight of the composition. In certain embodiments, the antimicrobial composition comprises from about 0.01 wt % and to 0.2 wt % of the peroxycarboxylic acid; from about 0.01 wt % to about 10 wt % of the carboxylic acid; from about 0.02 wt % to about 1 wt % of the anionic surfactant; and water. In some embodiments, a weight ratio of the peroxycarboxylic acid:the carboxylic acid in the antimicrobial composition is from about 0.005:1 to about 4:1. In certain embodiments, a weight ratio of the peroxycarboxylic acid:the carboxylic acid is from about 0.005:1 to about 2:1. In still further embodiments, a weight ratio of the peroxycarboxylic acid:the carboxylic acid is from about 0.005:1 to about 1.66:1. In yet some embodiments, the antimicrobial composition further comprises a nonionic surfactant.

In the second aspect, a synergistic antimicrobial composition is provided that comprises a quaternary ammonium salt in an amount from about 0.08 wt % to about 0.8 wt % based on total weight of the composition, a carboxylic acid in an amount of from about 0.008 wt % to about 10 wt % based on total weight of the composition, and water. The antimicrobial composition has a pH of no more than 7, and may comprise a pH adjusting acid. In some embodiments, the antimicrobial composition has a pH of less than 5. In certain embodiments, the antimicrobial composition has a pH of less than 3. The antimicrobial composition may further comprise an organic solvent to assist in the dispersion and stabilization of the quaternary ammonium salt in water. In some embodiments, the organic solvent is present in an amount of from about 0.096 wt % to about 10 wt % based on total weight of the antimicrobial composition. In some embodiments, the quaternary ammonium salt comprises cetyl pyridinium chloride. In some embodiments, the carboxylic acid is present in an amount of from about 0.02 wt % to about 10 wt % based on total weight of the composition. In some embodiments, a weight ratio of the quaternary ammonium salt:the carboxylic acid is from about 1:0.01 to about 1:125. In some embodiments, a weight ratio of the quaternary ammonium salt:the carboxylic acid is from about 1:0.10 to about 1:12.5. In yet some embodiments, the antimicrobial composition further comprises an anionic surfactant, a nonionic surfactant, or a combination thereof. When desired, the anionic surfactant may be present in an amount of from about 0.002 wt % to about 3.3% based on total weight of the composition. In certain embodiments, the nonionic surfactant is present in an amount of from about 0.002 wt % to about 2.3% based on total weight of the composition.

In the third aspect, a synergistic antimicrobial composition is provided that comprises a quaternary ammonium salt in an amount of from about 0.08 wt % to about 0.80 wt % based on total weight of the composition, a peroxycarboxylic acid in an amount of from about 0.006 wt % to about 0.20 wt % based on total weight of the composition, and water. The antimicrobial composition has a pH of no more than 7, and may comprise a pH adjusting acid. In some embodiments, the antimicrobial composition has a pH of less than 5. In certain embodiments, the antimicrobial composition has a pH of less than 3. The antimicrobial composition may further comprise an organic solvent to assist in the dispersion and stabilization of the quaternary ammonium salt in water. In some embodiments, the organic solvent is present in an amount of from about 0.096 wt % to about 10 wt % based on total weight of the antimicrobial composition. In some embodiments, the quaternary ammonium salt comprises cetyl pyridinium chloride. In some embodiments, a weight ratio of the quaternary ammonium salt:the peroxycarboxylic acid is from about 1:0.0125 to about 1:2.5. In certain embodiments, a weight ratio of the quaternary ammonium salt:the peroxycarboxylic acid is from about 1:0.10 to about 1:2.5. In yet some embodiments, the antimicrobial composition further comprises an anionic surfactant, a nonionic surfactant, or a combination thereof. When desired, the anionic surfactant may be present in an amount of from about 0.01 wt % to about 3.33 wt % based on total weight of the composition. In certain embodiments, the nonionic surfactant is present in an amount of from about 0.07 wt % to about 2.33 wt % based on total weight of the composition.

In further aspect, a method of reducing microbial contaminants is provided that comprises contacting the poultry, the surfaces used in processing poultry, or both with any one of the aforementioned synergistic antimicrobial compositions during poultry processing. The method may provide an antimicrobial efficacy that passes the FSIS antimicrobial reduction performance standards with nBPW as neutralizer, without any carry over after neutralization.

Other aspects of the disclosure will become apparent by consideration of the detailed description.

### DETAILED DESCRIPTION

The present disclosure generally relates to the synergistic antimicrobial compositions that provide an excellent antimicrobial efficacy with the use of nBPW neutralizer, and to the methods of reducing microbial contaminants during poultry processing. The antimicrobial compositions may be used for washing, rinsing, chilling, air cooling, or scalding the poultry carcasses, carcass parts, or organs to reduce antimicrobial contaminants.

The terms “comprise(s),” “comprising,” “include(s),” “including,” “having,” “has,” “contain(s),” “containing,” and variants thereof, as used herein, are open-ended transitional phrases that are meant to encompass the items listed thereafter and equivalents thereof as well as additional items. The singular forms “a”, “an”, and “the” include plural references unless the context clearly dictates otherwise. Where the term “comprising” is used, the present disclosure also contemplates other embodiments “comprising”, “consisting of”, or “consisting essentially of” elements presented herein, whether explicitly set forth or not.

The phrase “consist(s) essentially of” or “consisting essentially of”, as used herein, is meant to encompass the items listed thereafter and equivalents thereof, and to lack any item that materially affects the basic and novel characteristics of the antimicrobial compositions or methods.

The phrase “consist(s) of” or “consisting of”, as used herein, is a close-ended transitional phrase that is meant to encompass the items listed thereafter and equivalents thereof, and to exclude any unlisted item.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this present disclosure.

The term “about” used in connection with a quantity is inclusive of the stated value and has the meaning dictated by the context (for example, it includes at least the degree of error associated with the measurement of the particular quantity). The term “about” refers to plus or minus 10% of the indicated number. For example, “about 10%” indicates a range of 9% to 11%, and “about 1%” means a range of 0.9% to 1.1%. Other meanings of “about” may be apparent from the context, such as rounding off, so, for example “about 1” may also mean from 0.5 to 1.4.

In general, the amount of a component in a composition as disclosed herein is expressed “by weight”, “wt %”, or “%”, which refers to the percentage of the component's weight in the total weight of the composition. Unless indicated otherwise, all concentrations are expressed as weight percentage concentrations.

The term “effective amount” refers to an amount effective that would achieve a desired effect or result. For example, an effective amount of an antimicrobial composition refers to the amount of such composition to achieve a level of antimicrobial efficacy, which can be measured with a standardized test known in the art. An effective amount of the antimicrobial composition may be determined by known methods and may vary according to factors such as the microbial strains, test media, temperature, and other conditions.

The term “substantially free” refers to an antimicrobial composition that does not contain a particular compound, or to which a particular compound has not been intentionally added to the antimicrobial composition. Should the particular compound be present, the amount of such particular compound shall be less than 1% by weight, preferably less than 0.5% by weight.

The term “poultry” includes chicken, turkey, ostrich, game hen, squab, guinea fowl, pheasant, quail, duck, goose, emu, or the like. Poultry includes whole or sectioned, and encompasses all forms of poultry flesh, by-products, and side products. The flesh of poultry includes muscle, fat, organs, skin, bones and body fluids and like components that form the animal.

The phrase “poultry processing surface” refers to a surface of a tool, a machine, equipment, a structure or the like that is employed as part of the poultry processing, preparation, or storage activity. Non-limiting examples of the poultry processing surfaces include the surfaces of poultry processing or preparation equipment, the surfaces of poultry processing wares or utensils, the surfaces of floors, walls, or fixtures of structures in which poultry processing occurs, etc. Non-limiting examples of poultry processing utensils or tools include knife, sharpening steel, sharpening stone, scalding barrel, tank, hook, blood-catching trough, wash trough, hand wash-basin, rack, bin, meat wrapping table, or the like.

### Peroxycarboxylic Acid

The term “peroxycarboxylic acid” refers to a chemical compound having the formula R—(CO₃H)ₙ, wherein:
R is an alkyl, aryl alkyl, cycloalkyl, aromatic, heterocyclic group, or any combination thereof; and
n is one, two, or three, or more. The R group may be saturated, unsaturated, substituted, unsubstituted, linear chain, branched chain, cyclic structure, or any combination thereof.

Non-limiting examples of suitable peroxycarboxylic acids include, but are not limited to, performic acid, peracetic acid, peroxypentanoic acid, peroxyhexanoic acid (aka caproic acid), peroxyheptanoic acid, peroxyoctanoic acid (aka percaprylic acid), peroxynonanoic acid, peroxydecanoic acid (aka percapric acid), peroxyundecanoic acid, peroxydodecanoic acid (aka perlauric acid), perglycolic acid, peroxyascorbic acid, peroxyadipic acid, peroxycitric acid, peroxypimelic acid, peroxysuberic acid, or the like.

In some embodiments of the present disclosure, the peroxycarboxylic acids include, but are not limited to, performic acid, peracetic acid, peroxyoctanoic acid, peroxydecanoic acid, peroxydodecanoic acid, perglycolic acid, or any mixture thereof.

### Carboxylic Acid

The term “carboxylic acid” refers to a chemical compound having the formula R—(COOH)ₙ, wherein:
R is an alkyl, aryl alkyl, cycloalkyl, aromatic, heterocyclic group, or any combination thereof; and
n is one, two, or three, or more. The R group may be saturated, unsaturated, substituted, unsubstituted, linear chain, branched chain, cyclic structure, or any combination thereof.

In some embodiments, the carboxylic acid may contain carbon atoms in a range of from one carbon to 20 carbon groups.

The carboxylic acid compound for the present disclosure comprises a carboxylic acid group (i.e., one or more carboxylic acid groups), and optionally a hydroxy group (i.e., one or more hydroxy groups). In some embodiments, the carboxylic acid comprises no hydroxy group. In some embodiments, the carboxylic acid comprises at least one hydroxy group.

In some embodiments, the carboxylic acid is composed of only one carboxylic acid compound. In some embodiments, the carboxylic acid is a blend of at least two carboxylic acid compounds.

In some embodiments, the carboxylic acid comprises only one carboxylic acid group. Examples of such carboxylic acids include, but are not limited to, formic acid, acetic acid, propionic acid, pentanoic acid (aka valeric acid), hexanoic acid (aka caproic acid), octanoic acid (aka caprylic acid), nonanoic acid, decanoic acid (aka capric acid), undecanoic acid, dodecanoic acid (aka lauric acid), cinnamic acid, benzoic acid, or the like.

In some embodiments, the carboxylic acid comprises more than one carboxylic acid groups. Examples of such carboxylic acids include, but are not limited to, succinic acid, adipic acid, itaconic acid, oxalic acid, fumaric acid, aconitic acid, pimelic acid, suberic acid, or the like.

In some embodiments, the carboxylic acid comprises at least one carboxylic acid group and at least one hydroxy group. The hydroxy group(s) of the carboxylic acid may be at any positions in relation to the carboxylic acid group(s), including but not limited to: α-position, β-position, and/or γ-position in relation to the carboxylic acid group(s). In some embodiments, the carboxylic acid may be α-hydroxy carboxylic acid, β-hydroxy carboxylic acid, γ-hydroxy carboxylic acid, polyhydroxy carboxylic acid, or any mixture thereof. Examples of such carboxylic acids include, but are not limited to, glycolic acid, lactic acid, citric acid, gluconic acid, malic acid, salicylic acid, tartartic acid, ascorbic acid, erythorbic acid, arginic acid, mandelic acid, or the like.

### Quaternary Ammonium Salt

The term “quaternary ammonium salt” refers to a chemical compound having the formula NR¹R²R³R⁴. X, wherein:
X is an anionic ion,
each of R¹, R², R³, and R⁴ is independently chosen from an alkyl, aryl alkyl, cycloalkyl, aromatic, heterocyclic group, or any combination thereof; and
n is one, two, or three, or more. The R group may be saturated, unsaturated, substituted, unsubstituted, linear chain, branched chain, cyclic structure, or any combination thereof.

Any quaternary ammonium salt suitable as an antimicrobial compound for direct food contact application may be used in the present disclosure. Examples of quaternary ammonium salts include, but are not limited to, cetyl pyridinium chloride (“CPC”), benzalkonium chloride, didecyl dimethyl ammonium chloride, octyl decyl dimethyl ammonium chloride, or the like.

In some embodiments, the quaternary ammonium salt comprises a pyridinium-based salt. In certain embodiments, the quaternary ammonium salt comprises cetyl pyridinium chloride.

### Anionic Surfactant

Anionic surfactants suitable for the present disclosure may be considered GRAS or otherwise approved for safe use in the context of the application in which they are employed. Examples of such anionic surfactants may include, but are not limited to: sulfate-based surfactant, sulfonate-based surfactant, sarcosinate-based surfactant, sulfosuccinate-based surfactant, carboxylate-based surfactant, phosphate ester-based surfactant, or the like.

Examples of sulfate-based surfactants may include, but are not limited to, alkyl sulfates (e.g., sodium lauryl sulfate, sodium 2-ethylhexyl sulfate), alkyl ether sulfates (e.g., sodium laureth sulfate), alkyl ethoxysulfates, fatty oleyl glycerol sulfates, alkyl phenol ethylene oxide ether sulfates, glucamine sulfates, or the like.

Examples of sulfonate-based surfactants may include, but are not limited to, alkyl sulfonate such as sodium octyl sulfonate, C5-C20 alkyl benzenesulfonic acid, C5-C20 alkyl benzenesulfonate, olefin sulfonate, or the like.

Examples of sarcosinate-based surfactants may include, but are not limited to, sodium myristoyl sarcosinate, sodium lauroyl sarcosinate, sodium oleoyl sarcosinate, sodium cocoyl sarcosinate, or the like.

Examples of sulfosuccinate-based surfactants may include, but are not limited to, sodium dioctyl sulfosuccinate, sodium monododecyl sulfosuccinate, sodium bis(2-ethylhexyl) sulfosuccinate, disodium laureth sulfosuccinate, or the like.

Suitable carboxylate-based surfactants may include, but are not limited to, carboxylate salt, ester carboxylic salt, ether carboxylic salt, or the like. Non-limiting examples of carboxylates surfactants include capryleth-9-carboxylic acid, alkyl ethoxy carboxylate, alkyl aryl ethoxy carboxylate, alkyl polyethoxy polycarboxylate surfactant, etc.

Examples of phosphate ester-based surfactants may include, but are not limited to, phosphate ester of natural fatty acid, phosphate ester of ethoxylated alcohol, phosphate ester of alkyl phenol ethoxylate, phosphate ester of polyoxyethylenated alkylphenol, or the like.

In some embodiments, the anionic surfactant includes alkyl sulfonate, alkyl aryl sulfonate, alkylated diphenyl oxide disulfonate, alkylated naphthalene sulfonate, alcohol alkoxylate carboxylate, sarcosinate, taurate, acyl amino acid, alkanoic ester, phosphate ester, sulfuric acid ester, salt or acid form thereof, or any mixture thereof.

In some embodiments, the anionic surfactant includes sodium lauryl sulfate, sodium octyl sulfonate, sodium lauroyl sarcosinate, sodium octyl sulfosuccinate, capryleth-9-carboxylic acid, phosphate ester of natural fatty acid, or any mixture thereof.

Furthermore, suitable anionic surfactants may include, but are not limited to, sulfonic acids or salts thereof, such as isethionate, alkyl aryl sulfonic acids, salt form thereof, or any mixture thereof.

### Nonionic Surfactant

Nonionic surfactants suitable for the present disclosure may be considered GRAS or otherwise approved for safe use in the context of the application in which they are employed.

Examples of nonionic surfactants may include, but are not limited to: glucoside surfactants such as alkyl polyglucoside (C8-C10), coco polyglucoside (C8-C16), and lauryl poly glucoside (C12-C16); alcohol alkoxylate surfactants such as R-(EO)₅(PO)₅ surfactant and R-(EO)₃(PO)₃ surfactant; alkoxylated surfactants such as EO/PO copolymer; sorbitan surfactants such as polyoxylene sorbitan monooleate; fatty acid esters such as C5-C20 alkyl fatty acid ester; fatty alcohols such as C5-C20 alkyl alcohol; amine oxide surfactants such as octyldimethylamine oxide, nonyldimethylamine oxide, decyldimethylamine oxide, undecyldimethylamine oxide, dodecyldimethylamine oxide, isododecyldimethyl amine oxide, tridecyldimethylamine oxide, bis(2-hydroxyethyl)-3-dodecoxy-1-hydroxypropylamine oxide, tetradecyldimethylamine oxide, dimethyl-(2-hydroxydodecyl)amine oxide, 3,6,9-trioctadecyldimethylamine oxide, 3-dodecoxy-2-hydroxypropyldi-(2-hydroxyethyl)amine oxide, or the like.

In some embodiments, the nonionic surfactant includes alkyl poly glucoside (C8-C10), coco poly glucoside (C8-C16), lauryl poly glucoside (C12-C16), or any mixture thereof.

### pH Adjusting Acid

The antimicrobial composition may comprise a pH adjusting acid to provide the composition with the desired pH range. Any pH adjusting acid that is suitable for direct food contact application may be used in the present disclosure.

Examples of such pH adjusting acids include, but are not limited to, sulfuric acid, alkyl sulfonic acid, alkyl aryl sulfonic acid, aryl sulfonic acid, or the like. As non-limiting examples, the pH adjusting acid may include methane sulfonic acid, sulfuric acid, p-toluene sulfonic acid, benzene sulfonic acid, or any mixture thereof.

### Organic Solvent

When desired, the antimicrobial composition may comprise an organic solvent. Examples of such solvent include, but are not limited to, propylene glycol, glycol ether, polyalkylene oxide, capped polyalkylene oxide, alkyl polyalkylene oxide, or any mixture thereof.

As non-limiting examples, suitable glycol ethers may include diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether, propylene glycol phenyl ether, or the like.

Non-limiting examples of suitable polyalkylene oxides include polyethylene glycol, polypropylene glycol, polybutylene glycol, mixtures thereof, or the like. Non-limiting examples of capped polyalkylene oxides include mono-alkyl and di-alkyl ethers of the respective polyalkylene oxides, such as mono- and di-methyl ethers of polyalkylene glycol, mono- and di-ethyl ethers of polyalkylene glycol, mono- and di-propyl ethers of polyalkylene glycol, mono- and di-butyl ethers of polyalkylene glycol, or the like. Suitable capped polyalkylene oxides include methyl polyethylene glycol (e.g., the monomethyl ether of polyethylene glycol), dimethyl polyethylene glycol (e.g., the dimethyl ether of polyethylene glycol), or the like.

In some embodiments, the organic solvent comprises propylene glycol, glycol ether, polyalkylene oxide, alkyl polyalkylene oxide, or any mixture thereof.

### Synergistic Antimicrobial Composition Comprising Peroxycarboxylic Acid and Carboxylic Acid

In one aspect, a synergistic antimicrobial composition comprises:
a peroxycarboxylic acid in an amount of from about 0.006 wt % to about 0.20 wt % based on total weight of the composition;
a carboxylic acid in an amount of from about 0.008 wt % to about 10 wt % based on total weight of the composition;
an anionic surfactant; and
water,
wherein the antimicrobial composition has a pH no more than 7, preferably less than 5, most preferably less than 3.

The antimicrobial composition may comprise a pH adjusting acid. In some embodiments, the antimicrobial composition has a pH of no more than 7. In some embodiments, the antimicrobial composition has a pH of less than 5. In certain embodiments, the antimicrobial composition has a pH of less than 3. In some embodiments, the antimicrobial composition has a pH of at least 0.10 or 1.0; and/or a pH of no more than 3.0, 4.0, 5.0 or 7.0.

In some embodiments, the peroxycarboxylic acid is present in an amount of at least 0.006 wt % (60 ppm), 0.01 wt % (100 ppm), 0.025 wt % (250 ppm), 0.05 wt % (500 ppm), 0.06 wt % (600 ppm) or 0.1 wt % (1000 ppm); and/or no more than 0.01 wt %, 0.025 wt %, 0.05 wt %, 0.06 wt %, 0.1 wt % or 0.20 wt % based on total weight of the antimicrobial composition. In some embodiments, the peroxycarboxylic acid is present in an amount of from about 0.01 wt % to about 0.20 wt % based on total weight of the composition.

In some embodiments, the carboxylic acid is present in an amount of at least 0.008 wt % (80 ppm), 0.01 wt % (100 ppm), 0.0125 wt % (100 ppm), 0.015 wt % (150 ppm), 0.017 wt % (170 ppm), 0.020 wt % (200 ppm), 0.025 wt % (250 ppm), 0.05 wt % (500 ppm), 0.06 wt % (600 ppm), 0.08 wt % (800 ppm), 0.10 wt % (1000 ppm), 0.125 wt %, (1250 ppm), 0.15 wt % (1500 ppm), 0.20 wt % (2000 ppm), 0.25 wt %, 0.30 wt %, 0.40 wt %, 0.50 wt %, 0.60 wt %, 0.80 wt %, 1.00 wt %, 1.20 wt %, 1.25 wt %, 2.00 wt %, 2.50 wt %, 2.55 wt %, 3.00 wt %, 4.00 wt % or 5.00 wt %; and/or no more than 0.0125 wt %, 0.015 wt %, 0.017 wt %, 0.020 wt %, 0.025 wt %, 0.05 wt %, 0.06 wt %, 0.08 wt %, 0.10 wt %, 0.125 wt %, 0.15 wt %, 0.20 wt %, 0.25 wt %, 0.30 wt %, 0.40 wt %, 0.50 wt %, 0.60 wt %, 0.80 wt %, 1.00 wt %, 1.20 wt %, 1.25 wt %, 2.00 wt %, 2.50 wt %, 2.55 wt %, 3.00 wt %, 4.00 wt %, 5.00 wt %, 6.00 wt % or 10.00 wt % based on total weight of the antimicrobial composition. In some embodiments, the carboxylic acid is present in an amount of from about 0.015 wt % to about 10 wt % based on total weight of the composition. In certain embodiments, the carboxylic acid is present in an amount of from about 0.10 wt % to about 10 wt % based on total weight of the composition.

In some embodiments, a weight ratio of the peroxycarboxylic acid:the carboxylic acid in the antimicrobial composition is at least 0.005:1, 0.01:1, 0.02:1, 0.025:1, 0.05:1, 0.10:1, 0.20:1, 0.25:1, 0.40:1, 0.66:1, 0.80:1, 1:1, 1:1.25, 1.34:1 or 1.5:1; and/or no more than 0.025:1, 0.05:1, 0.10:1, 0.20:1, 0.25:1, 0.40:1, 0.66:1, 0.80:1, 1:1, 1:1.25, 1.34:1, 1.5:1, 1.66:1, 2; 1 or 4:1. In some embodiments, a weight ratio of the peroxycarboxylic acid:the carboxylic acid in the antimicrobial composition is from about 0.005:1 to about 4:1. In some embodiments, a weight ratio of the peroxycarboxylic acid:the carboxylic acid in the antimicrobial composition is from about 0.005:1 to about 2:1. In still further embodiments, a weight ratio of the peroxycarboxylic acid:the carboxylic acid is from about 0.005:1 to about 1.66:1.

In some embodiments, the anionic surfactant is present in an amount of at least in 0.001 wt % (10 ppm), 0.002 wt % (20 ppm), 0.003 wt % (30 ppm), 0.006 wt % (60 ppm), 0.01 wt % (100 ppm), 0.011 wt % (110 ppm), 0.013 wt % (130 ppm), 0.014 wt % (140 ppm), 0.02 wt % (200 ppm), 0.03 wt % (300 ppm), 0.06 wt % (600 ppm), 0.14 wt % or 0.22 wt %; and/or no more than 0.003 wt %, 0.006 wt %, 0.01 wt %, 0.011 wt %, 0.013 wt %, 0.014 wt %, 0.02 wt %, 0.03 wt %, 0.06 wt %, 0.14 wt %, 0.22 wt %, 0.28 wt % or 1.1 wt % based on total weight of the antimicrobial composition. In some embodiments, the antimicrobial composition comprises the anionic surfactant in an amount of from about 0.001 wt % to about 1.1 wt %. In certain embodiments, an amount of the anionic surfactant is from about 0.02 wt % to about 1 wt % based on total weight of the composition.

In some embodiments, the antimicrobial composition comprises from about 0.01 wt % to about 0.2 wt % of the peroxycarboxylic acid; from about 0.01 wt % to about 10 wt % of the carboxylic acid; from about 0.02 wt % to about 1 wt % of the anionic surfactant; and water, all based on total weight of the composition. Such antimicrobial composition has a pH no more than 7, preferably less than 5, most preferably less than 3.

In some embodiments, the antimicrobial composition may further comprises a nonionic surfactant. An amount of the nonionic surfactant may be at least 0.003 wt % (30 ppm), 0.004 wt % (40 ppm), 0.007 wt % (70 ppm), 0.014 wt % (140 ppm), 0.028 wt % (280 ppm), 0.03 wt % (300 ppm), 0.035 wt % (350 ppm), 0.06 wt % (600 ppm), 0.07 wt % (700 ppm), 0.14 wt % (1400 ppm), 0.28 wt %, 0.35 wt % or 0.5 wt %; and/or no more than 0.03 wt %, 0.035 wt %, 0.06 wt %, 0.07 wt %, 0.14 wt %, 0.28 wt %, 0.35 wt %, 0.5 wt %, 0.56 wt %, 0.70 wt %, 2 wt % or 2.8% based on total weight of the antimicrobial composition. In some embodiments, the nonionic surfactant is present in an amount of from about 0.003% to 2.8 wt % based on total weight of the antimicrobial composition. In certain embodiments, the nonionic surfactant is present in an amount of from about 0.02 wt % to about 2 wt % based on total weight of the antimicrobial composition.

In some embodiments, the synergistic antimicrobial composition comprises, based on total weight of the composition:
from about 0.01 wt % and to 0.2 wt % of the peroxycarboxylic acid;
from about 0.1 wt % to about 10 wt % of the carboxylic acid;
from about 0.02 wt % to about 1 wt % of the anionic surfactant;
optionally, from about 0.02 wt % to about 2 wt % of the nonionic surfactant; and
water, wherein the antimicrobial composition has a pH no more than 7, preferably less than 5, most preferably less than 3.

When desired, the synergistic antimicrobial composition may further comprise antimicrobial solvent, wetting agent, stabilizing agent, hydrotope, thickener, foaming agent, defoaming agent, surfactant, or any combination thereof. Non-limiting examples of suitable antimicrobial solvents include acetamidophenol; acetanilide; acetophenone; 2-acetyl-1-methylpyrrole; benzyl acetate; benzyl alcohol; benzyl benzoate; benzyloxyethanol; essential oils (e.g., benzaldehyde, pinenes, terpineols, terpinenes, carvone, cinnamealdehyde, bomeol and its esters, citrals, ionenes, jasmine oil, limonene, dipentene, linalool and its esters); diester dicarboxylates (e.g., dimethyl adipate, dimethyl succinate, dimethyl glutarate, dimethyl malonate, diethyl adipate, diethyl succinate, diethyl glutarate, dibutyl succinate, and dibutyl glutarate, dimethyl sebacate, dimethyl pimelate, dimethyl suberate); or dialkyl carbonates (e.g., dimethyl carbonate, diethyl carbonate, dipropyl carbonate, diisopropyl carbonate, dibutyl carbonate).

### Method of Reducing Microbial Contaminants During Poultry Processing

The aforementioned synergistic antimicrobial compositions comprising peroxycarboxylic acid and carboxylic acid may be used for reducing microbial contaminants, especially during poultry processing.

The method of reducing microbial contaminants comprises contacting the poultry, the surfaces used in processing poultry, or both during poultry processing with the disclosed synergistic antimicrobial composition comprising peroxycarboxylic acid and carboxylic acid.

The use of peroxycarboxylic acid at an amount of from about 0.006 wt % to about 0.20 wt %, in combination with carboxylic acid at an amount of from about 0.008 wt % to about 10 wt % based on total weight of the composition, during poultry processing provides an unexpected synergistic antimicrobial effect. See EXAMPLES 1 to 13. Various weight ratios of the peroxycarboxylic acid:the carboxylic acid may be used in the disclosed synergistic antimicrobial composition. See EXAMPLE 12.

Various peroxycarboxylic acids may be used for the present disclosure, in combination with carboxylic acid to provide an unexpected synergistic antimicrobial effect. See EXAMPLES 1 to 4 for peracetic acid as the peroxycarboxylic acid; EXAMPLE 5 for perglycolic acid as the peroxycarboxylic acid; EXAMPLE 6 for performic acid as the peroxycarboxylic acid; EXAMPLE 7 for percaprylic acid as the peroxycarboxylic acid; EXAMPLE 8 for percapric acid as the peroxycarboxylic acid; and EXAMPLE 9 for perlauric acid as the peroxycarboxylic acid.

Various carboxylic acids may be used for the present disclosure, in combination with peroxycarboxylic acid to provide an unexpected synergistic antimicrobial effect. See EXAMPLES 1 and 2 for some of the carboxylic acids containing only one carboxylic acid group; EXAMPLE 3 for some of the carboxylic acids containing at least one carboxylic acid group and at least one hydroxyl group; EXAMPLE 4 for some of the carboxylic acids containing more than one carboxylic acid groups; and EXAMPLES 5 to 9.

In addition to peroxycarboxylic acid and carboxylic acid, the disclosed synergistic antimicrobial composition comprises an anionic surfactant to further enhance the unexpected synergistic antimicrobial effect against microbial contaminants. Various anionic surfactants may be used in the disclosed synergistic antimicrobial composition. See EXAMPLES 10 and 11.

In some embodiments, the disclosed synergistic antimicrobial composition may further comprise a nonionic surfactant, a pH adjusting agent, or a combination thereof. However, these optional chemical ingredients do not necessarily contribute to the unexpected synergistic antimicrobial effect. See EXAMPLE 10.

The disclosed synergistic antimicrobial composition provides an unexpected synergistic antimicrobial effect in controlling and/or reducing various microbial contaminants. Some non-limiting examples of such microbial contaminants include, but are not limited to, Salmonella enterica, Salmonella typhimurium, Escherichia coli, Campylobacter jejuni, Listeria monocytogenes, or any combination thereof. See EXAMPLE 13.

### Synergistic Antimicrobial Composition Comprising Quaternary Ammonium Salt and Carboxylic Acid

In one aspect, a synergistic antimicrobial composition comprises:
a quaternary ammonium salt in an amount from about 0.08 wt % to about 0.8 wt % based on total weight of the composition;
a carboxylic acid in an amount of from about 0.008 wt % to about 10 wt % based on total weight of the composition; and
water, wherein the antimicrobial composition has a pH no more than 7, preferably less than 5, most preferably less than 3.

The antimicrobial composition has a pH of no more than 7, and may comprise a pH adjusting acid. In some embodiments, the antimicrobial composition has a pH of less than 5. In certain embodiments, the antimicrobial composition has a pH of less than 3. In some embodiments, the antimicrobial composition has a pH of at least 0.10 or 1.0; and/or a pH of no more than 3.0, 4.0, 5.0 or 7.0.

In some embodiments, the quaternary ammonium salt comprises cetyl pyridinium chloride.

In some embodiments, the carboxylic acid is present in an amount of from about 0.02 wt % to about 10 wt % based on total weight of the composition.

In some embodiments, a weight ratio of the quaternary ammonium salt:the carboxylic acid is at least 1:0.01, 1:0.0125, 1:0075, 1:0.10, 1:0.125, 1:0.25, 1:0.50, 1:1:1, 1:3.75 or 1:10; and/or no more than 1:0.10, 1:0.125, 1:0.25, 1:0.50, 1:0.75, 1:1, 1:3.75, 1:10, 1:12.5 or 1:125. In some embodiments, a weight ratio of the quaternary ammonium salt:the carboxylic acid is from about 1:0.10 to about 1:125. In some embodiments, a weight ratio of the quaternary ammonium salt:the carboxylic acid is from about 1:0.10 to about 1:12.5.

The antimicrobial composition may further comprise an organic solvent to assist in the dispersion and stabilization of the quaternary ammonium salt in water. In some embodiments, the organic solvent is present in an amount of from about 0.096 wt % to about 10 wt % based on total weight of the antimicrobial composition. In some embodiments, the quaternary ammonium salt comprises cetyl pyridinium chloride (CPC), and the weight amount of organic solvent is about 1.2 times of the CPC weight.

In yet some embodiments, the antimicrobial composition further comprises an anionic surfactant, a nonionic surfactant, or a combination thereof.

In some embodiments, the anionic surfactant may be present in an amount of from about 0.002 wt % to about 3.3 wt % based on total weight of the composition.

In some embodiments, the nonionic surfactant is present in an amount of from about 0.002 wt % to about 2.3% based on total weight of the composition.

In some embodiments, the synergistic antimicrobial composition comprises, based on total weight of the composition:
from about 0.08 wt % to about 0.8 wt % of cetyl pyridinium chloride as the quaternary ammonium salt;
from about 0.1 wt % to about 10 wt % of the carboxylic acid;
optionally, from about 0.096 wt % to about 10 wt % of the organic solvent; and water,
wherein the antimicrobial composition has a pH no more than 7, preferably less than 5, most preferably less than 3.

When desired, the disclosed synergistic antimicrobial composition may further comprise antimicrobial solvent, wetting agent, stabilizing agent, hydrotope, thickener, foaming agent, defoaming agent, surfactant, or any combination thereof. Non-limiting examples of suitable antimicrobial solvents include acetamidophenol; acetanilide; acetophenone; 2-acetyl-1-methylpyrrole; benzyl acetate; benzyl alcohol; benzyl benzoate; benzyloxyethanol; essential oils (e.g., benzaldehyde, pinenes, terpineols, terpinenes, carvone, cinnamealdehyde, bomeol and its esters, citrals, ionenes, jasmine oil, limonene, dipentene, linalool and its esters); diester dicarboxylates (e.g., dimethyl adipate, dimethyl succinate, dimethyl glutarate, dimethyl malonate, diethyl adipate, diethyl succinate, diethyl glutarate, dibutyl succinate, and dibutyl glutarate, dimethyl sebacate, dimethyl pimelate, dimethyl suberate); or dialkyl carbonates (e.g., dimethyl carbonate, diethyl carbonate, dipropyl carbonate, diisopropyl carbonate, dibutyl carbonate).

### Method of Reducing Microbial Contaminant During Poultry Processing

The aforementioned synergistic antimicrobial compositions comprising quaternary ammonium salt and carboxylic acid may be used for reducing microbial contaminants, especially during poultry processing.

The method of reducing microbial contaminants comprises contacting the poultry, the surfaces used in processing poultry, or both during poultry processing with the disclosed synergistic antimicrobial composition comprising quaternary ammonium salt and carboxylic acid.

The use of quaternary ammonium salt (e.g., cetyl pyridinium chloride) at an amount from about 0.08 wt % to about 0.8 wt %, in combination with carboxylic acid at an amount of from about 0.008 wt % to about 10 wt %, based on total weight of the composition during poultry processing provides an unexpected synergistic antimicrobial effect. See EXAMPLES 14 to 18. Various carboxylic acids may be used for the present disclosure. See EXAMPLE 14. Furthermore, various weight ratios of the quaternary ammonium salt:the carboxylic acid may be used in the disclosed synergistic antimicrobial composition. See EXAMPLE 16.

In some embodiments, the disclosed synergistic antimicrobial composition may further comprise an organic solvent, an anionic surfactant, a nonionic surfactant, a pH adjusting agent, or any combination thereof. However, these optional chemical ingredients do not necessarily contribute to the unexpected synergistic antimicrobial effect. See EXAMPLES 15 and 17.

The disclosed synergistic antimicrobial composition provides an unexpected synergistic antimicrobial effect in controlling and/or reducing various microbial contaminants. Some non-limiting examples of such microbial contaminants include, but are not limited to, Salmonella enterica, Salmonella typhimurium, Escherichia coli, Campylobacter jejuni, Listeria monocytogenes, or any combination thereof. See EXAMPLE 18.

### Synergistic Antimicrobial Composition Comprising Quaternary Ammonium Salt and Peroxycarboxylic Acid

In one aspect, a synergistic antimicrobial composition comprises:
a quaternary ammonium salt in an amount of from about 0.08 wt % to about 0.80 wt % based on total weight of the composition;
a peroxycarboxylic acid in an amount of from about 0.006 wt % to about 0.20 wt % based on total weight of the composition; and
water, wherein the antimicrobial composition has a pH no more than 7, preferably less than 5, most preferably less than 3.

The antimicrobial composition has a pH of no more than 7, and may comprise a pH adjusting acid. In some embodiments, the antimicrobial composition has a pH of less than 5. In certain embodiments, the antimicrobial composition has a pH of less than 3. In some embodiments, the antimicrobial composition has a pH of at least 0.10 or 1.0; and/or a pH of no more than 3.0, 4.0, 5.0 or 7.0.

In some embodiments, the quaternary ammonium salt comprises cetyl pyridinium chloride.

In some embodiments, a weight ratio of the quaternary ammonium salt:the peroxycarboxylic acid is at least 1:0.0125, 1:0.075, 1:0.80, 1:0.10, 1:0.125, 1:0.15 or 1:0.20; and/or no more than 1:0.10, 1:0.125, 1:0.15, 1:0.20, 1:2.50, 1:0.30, 1:1 or 1:2.50. In some embodiments, a weight ratio of the quaternary ammonium salt:the peroxycarboxylic acid is from about 1:0.0125 to about 1:2.5. In certain embodiments, a weight ratio of the quaternary ammonium salt:the peroxycarboxylic acid is from about 1:0.10 to about 1:2.5.

The antimicrobial composition may further comprise an organic solvent to assist in the dispersion and stabilization of the quaternary ammonium salt in water. In some embodiments, the organic solvent is present in an amount of from about 0.096 wt % to about 10 wt % based on total weight of the antimicrobial composition. In some embodiments, the quaternary ammonium salt comprises cetyl pyridinium chloride (CPC), and the weight amount of organic solvent is about 1.2 times of the CPC weight.

In yet some embodiments, the antimicrobial composition further comprises an anionic surfactant, a nonionic surfactant, or a combination thereof.

In some embodiments, the anionic surfactant may be present in an amount of from about 0.01 wt % to about 3.33% based on total weight of the composition.

In some embodiments, the nonionic surfactant is present in an amount of from about 0.07 wt % to about 2.33% based on total weight of the composition.

In some embodiments, the synergistic antimicrobial composition comprises, based on total weight of the composition:
from about 0.08 wt % to about 0.8 wt % of cetyl pyridinium chloride as the quaternary ammonium salt;
from about 0.01 wt % to about 0.2 wt % of the peroxycarboxylic acid;
optionally from about 0.02 wt % to about 2 wt % of the nonionic surfactant;
optionally from about 0.096 wt % to about 10 wt % of the organic solvent; and
water,
wherein the antimicrobial composition has a pH no more than 7, preferably less than 5, most preferably less than 3.

When desired, the disclosed synergistic antimicrobial composition may further comprise antimicrobial solvent, wetting agent, stabilizing agent, hydrotope, thickener, foaming agent, defoaming agent, surfactant, or any combination thereof. Non-limiting examples of suitable antimicrobial solvents include acetamidophenol; acetanilide; acetophenone; 2-acetyl-1-methylpyrrole; benzyl acetate; benzyl alcohol; benzyl benzoate; benzyloxyethanol; essential oils (e.g., benzaldehyde, pinenes, terpineols, terpinenes, carvone, cinnamealdehyde, bomeol and its esters, citrals, ionenes, jasmine oil, limonene, dipentene, linalool and its esters); diester dicarboxylates (e.g., dimethyl adipate, dimethyl succinate, dimethyl glutarate, dimethyl malonate, diethyl adipate, diethyl succinate, diethyl glutarate, dibutyl succinate, and dibutyl glutarate, dimethyl sebacate, dimethyl pimelate, dimethyl suberate); or dialkyl carbonates (e.g., dimethyl carbonate, diethyl carbonate, dipropyl carbonate, diisopropyl carbonate, dibutyl carbonate).

### Method of Reducing Microbial Contaminant During Poultry Processing

The aforementioned synergistic antimicrobial compositions comprising quaternary ammonium salt and peroxycarboxylic acid may be used for reducing microbial contaminants, especially during poultry processing.

The method of reducing microbial contaminants comprises contacting the poultry, the surfaces used in processing poultry, or both during poultry processing with the disclosed synergistic antimicrobial composition comprising quaternary ammonium salt and peroxycarboxylic acid.

The use of quaternary ammonium salt (e.g., cetyl pyridinium chloride) at an amount of from about 0.08 wt % to about 0.80 wt %, in combination with peroxycarboxylic acid at an amount of from about 0.006 wt % to about 0.20 wt %, based on total weight of the composition during poultry processing provides an unexpected synergistic antimicrobial effect. See EXAMPLES 19 to 23. Various peroxycarboxylic acids may be used for the present disclosure. See EXAMPLE 19. Furthermore, various weight ratios of the quaternary ammonium salt:the peroxycarboxylic acid may be used in the disclosed synergistic antimicrobial composition. See EXAMPLE 22.

In some embodiments, the disclosed synergistic antimicrobial composition may further comprise an organic solvent, an anionic surfactant, a nonionic surfactant, a pH adjusting agent, or any combination thereof. However, these optional chemical ingredients do not necessarily contribute to the unexpected synergistic antimicrobial effect. See EXAMPLES 20 and 21.

The disclosed synergistic antimicrobial composition provides an unexpected synergistic antimicrobial effect in reducing various microbial contaminants. Some non-limiting examples of such microbial contaminants include, but are not limited to, Salmonella enterica, Salmonella typhimurium, Escherichia coli, Campylobacter jejuni, Listeria monocytogenes, or any combination thereof. See EXAMPLE 23.

The presently disclosed methods of reducing and/or controlling microbial contaminants during poultry processing may provide an antimicrobial efficacy that passes the FSIS antimicrobial reduction performance standards using nBPW as neutralizer, without any carry over after neutralization. See EXAMPLE 24.

The poultry or the surfaces used in processing poultry may be contacted with the antimicrobial composition by any known techniques. Non-limited examples of such contact may include submersing, rinsing, spraying, foaming, submersion scalding, submersion chilling, air chilling, hydro-cooling, tumble immersing, or any combination thereof with the antimicrobial composition. During poultry processing, the antimicrobial composition may be applied to whole, dismembered, portioned, or boned poultry.

The disclosed methods may effective kill one or more of the microbial associated with a food product. Non-limiting examples of such microbials may include Salmonella Enterica, Salmonella Typhimurium, Escherichia Coli, Campylobacter Jejuni, Listeria Monocytogenes, and other naturally occurring microbial contaminants.

The following non-limiting examples illustrate the floor finishing compositions of the present disclosure and methods of use thereof.

### EXAMPLES

### Method for Determining the Antimicrobial Efficacy

About 12-15 chicken drumettes were subjected to a pretreatment step using 500 ppm peracetic acid for 5 minutes to reduce the load of existing natural resident pathogens or pre-existing microflora of the chicken drumettes. The pretreated chicken drumettes were then subjected to inoculation with the tested microbial. After that, the inoculated chicken drumettes were allowed to drip for 20 minutes on sterile racks.

Three inoculated chicken drumettes were selected for enumeration of initial microbial levels by recovering the microbes in the nBPW neutralizer solution and dilution plating. The nBPW neutralizer solution had pH of about 7.7±0.5 at 25° C., and was made of 20 g of buffered peptone water, 12.5 g of sodium bicarbonate, 7 g of lecithin, and 1 g of sodium thiosulfate per liter of deionized water.

Three inoculated chicken drumettes were selected for treatment with water (i.e., control). The chicken drumettes were soaked with about 900 ml of water for 90 seconds, then removed from water. After that, the microbial levels on the chicken drumettes were determined by recovering the microbes in the nBPW neutralizer solution and dilution plating.

Three inoculated chicken drumettes were selected for treatment with the tested antimicrobial composition. The chicken drumettes were soaked with about 900 ml of the antimicrobial composition for 90 seconds, then removed from the antimicrobial composition. After that, the microbial levels on the chicken drumettes were determined by recovering the microbes in the nBPW neutralizer solution and dilution plating.

### Reporting of Antimicrobial Efficacy

The antimicrobial efficacy was reported as an average log₁₀ reduction. The term “log₁₀ reduction” is a mathematical term used to show the relative number of live microbial being reduced from a tested area. For example, “a log₁₀ reduction of 5” means lowering the number of microbial by 10⁵; “a log₁₀ reduction of 4” means lowering the number of microbial by 10⁴; “a log₁₀ reduction of 3” means lowering the number of microbial by 10³; “a log₁₀ reduction of 2” means lowering the number of microbial by 10²; and “a log₁₀ reduction of 1” means lowering the number of microbial by 10.

### Determination for the Existence of Synergic Effect

An existence of synergic effect between antimicrobial compounds in the tested antimicrobial composition was determined using Colby's equation below to calculate the Expected Antimicrobial Efficiency (E):

$$E = X + Y - \frac{XY}{100}$$

wherein:
X is an antimicrobial efficiency (reported in an antiLog₁₀ value of the log₁₀ reduction) of the first antimicrobial compound at a given amount (p),
Y is an antimicrobial efficiency (reported in an antiLog₁₀ value of the log₁₀ reduction) of the second antimicrobial compound at a given amount (q), and
E is an expected antimicrobial efficiency (reported in an antiLog₁₀ value of the log₁₀ reduction) when combining the first antimicrobial compound at a given amount (p) and the second antimicrobial compound at a given amount (q).

The Observed Antimicrobial Efficiency (reported in an antiLog₁₀ value of the log₁₀ reduction) was measured for the tested antimicrobial composition comprising the first antimicrobial compound at a given amount (p) and the second antimicrobial compound at a given amount (q).

Upon comparing the Observed Antimicrobial Efficiency to the Expected Antimicrobial Efficiency (E) as calculated using Colby's equation, an existence of synergic effect between the first and second antimicrobial compounds in the tested antimicrobial composition can be determined:
If the Observed Antimicrobial Efficiency is greater than the Expected Antimicrobial Efficiency (E), there is a synergistic effect between the first and second antimicrobial compounds in the tested antimicrobial composition;
If the Observed Antimicrobial Efficiency is equaled to or less than the Expected Antimicrobial Efficiency (E), there is no synergistic effect between the first and second antimicrobial compounds in the tested antimicrobial composition.

### Example 1

TABLE 1 showed the antimicrobial efficacy of the tested antimicrobial compositions against Salmonella Enterica ATCC 10708. Antimicrobial Compositions #1A, #1B, #C and #1D contained only peracetic acid (PAA) as an antimicrobial compound at 0.01 wt % (100 ppm), 0.025 wt % (250 ppm), 0.06 wt % (600 ppm), and 0.2 wt % (2000 ppm), respectively, based on the total weight of the composition. Antimicrobial Composition #1E did not contain any PAA; it contained propionic acid as an antimicrobial compound, alkyl polyglucoside as a nonionic surfactant, and sodium lauryl sulfate as an anionic surfactant. Antimicrobial Composition #1F was essentially the combination of Antimicrobial Compositions #1B and #1E. The tested antimicrobial compositions had pH of from about 1.0 to about 3.0, and methane sulfonic acid was used as a pH adjusting acid to achieve the desired pH value.

TABLE 1

| | #1A | #1B | #1C | #1D | #1E | #1F |
|---|---|---|---|---|---|---|
| Peracetic Acid (PAA) | 0.01% | 0.025% | 0.06% | 0.2% | — | 0.025% |
| Propionic Acid | — | — | — | — | 2.50% | 2.50% |
| Anionic Surfactant | — | — | — | — | 0.28% | 0.28% |
| Nonionic Surfactant | — | — | — | — | 0.70% | 0.70% |
| Water (including pH | q.s. to | q.s. to | q.s. to | q.s. to | q.s. to | q.s. to |
| adjusting agent) | 100% | 100% | 100% | 100% | 100% | 100% |
| Microefficiency against | | | | | | |
| Salmonella Enterica | | | | | | |
| Observed Average | 1.10 | 1.16 | 1.30 | 1.80 | 0.79 | 1.39 |
| Log₁₀ Reduction | | | | | | |
| Observed Average | 10^{1.10} = | 10^{1.16} = | 10^{1.30} = | 10^{1.80} = | 10^{0.79} = | 10^{1.39} = |
| Reduction | 12.59 | 14.45 | 19.95 | 63.10 | 6.17 | 24.55 |
| (AntiLog₁₀ value) | | | | | | |
| Expected Reduction | — | — | — | — | — | 19.73 |
| via Colby's Calculation | | | | | | |
| (AntiLog₁₀ value) | | | | | | |

The “Expected Reduction via Colby's Calculation (AntiLog₁₀ value)” in the table was calculated using Colby's equation below:

$$E = X + Y - \frac{XY}{100}$$

wherein
E was an expected antimicrobial efficiency (reported in an antiLog₁₀ value) when PAA was used in combination with propionic acid,
X was an antimicrobial efficiency of PAA and equaled to 14.15, which was an antiLog₁₀ value of the reported log₁₀ reduction of 1.16, and
Y was an antimicrobial efficiency of propionic acid and equaled to 6.17, which was an antiLog₁₀ value of the reported log₁₀ reduction of 0.79.

Thus, the Expected Antimicrobial Efficiency (E) in the antiLog₁₀ value unit was calculated to be 19.73, as shown below:

$$E = 14.15 + 6.17 - \frac{( 14.15 \times 6.17 )}{100} = 19.73$$

When PAA was used as the sole antimicrobial compound, the antimicrobial efficacy against Salmonella Enterica was less than log₁₀ reduction of 1.5 unless the use concentration of PAA was increased to more than 0.06 wt %. See Antimicrobial Compositions #1A, #1B, and #1C. Antimicrobial Composition #1D, which contained the maximum PAA concentration allowed by the governmental regulation (0.2 wt %), provided a log₁₀ reduction of 1.8. However, the poultry treated with an antimicrobial composition containing more than 0.08 wt % (800 ppm) PAA showed undesirable “grey” appearance.

Antimicrobial Composition #1E, which contained propionic acid as an antimicrobial compound, provided a log₁₀ reduction of 0.79.

Antimicrobial Composition #1F, which was essentially the combination of Antimicrobial Compositions #1B and #1E, contained both PAA and propionic acid as antimicrobial compounds. Antimicrobial Composition #1F provided a log₁₀ reduction of 1.39. Thus, the Observed Antimicrobial Efficiency, which was an antiLog₁₀ value of the 1.39 log₁₀ reduction, was 24.55.

As shown above, the Expected Antimicrobial Efficiency (E) of Composition #1F was calculated using Colby's equation to be an antiLog₁₀ value of only 19.73.

Since the Observed Antimicrobial Efficiency was greater than the Expected Antimicrobial Efficiency (E), TABLE 1 showed that there was a synergistic effect between PAA and propionic acid in Composition #1F.

### Example 2

TABLE 2 showed the antimicrobial efficacy of the antimicrobial compositions against Salmonella Enterica ATCC 10708 to demonstrate the synergistic effect between peracetic acid (PAA) and various carboxylic acids containing one carboxylic acid group. The tested carboxylic acids were formic acid, acetic acid, valeric acid, caproic acid, caprylic acid, and lauric acid. The concentration of PAA was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH value.

Antimicrobial Composition #2A, which contained PAA as the sole antimicrobial compound, provided an antimicrobial efficacy against Salmonella Enterica at a log₁₀ reduction of 1.16 (i.e., AntiLog₁₀ value of 14.45). Antimicrobial Composition #2B, which contained formic acid as an antimicrobial compound, provided a log₁₀ reduction of 1.74 (i.e., AntiLog₁₀ value of 54.95).

Antimicrobial Composition #2C, which was essentially the combination of Antimicrobial Compositions #2A and #2B, contained both PAA and formic acid as antimicrobial compounds. Antimicrobial Composition #2C provided the antimicrobial efficiency (“Observed Average Log₁₀ Reduction”) at a log₁₀ reduction of 2.16 (i.e., AntiLog₁₀ value of 144.54). The “Observed Average Reduction” of Antimicrobial Composition #2C at the AntiLog₁₀ value of 144.54 was substantially higher than the “Expected Reduction via Colby's Calculation” at the AntiLog₁₀ value of 61.46. Therefore, there was a synergistic effect between PAA and formic acid in Composition #2C.

Antimicrobial Composition #2D contained acetic acid as a sole antimicrobial compound, and provided a log₁₀ reduction of 1.03 (i.e., AntiLog₁₀ value of 10.72). Antimicrobial Composition #2E, which was essentially the combination of Antimicrobial Compositions #2A and #2D, contained both PAA and acetic acid as antimicrobial compounds. Antimicrobial Composition #2E provided the antimicrobial efficiency (“Observed Average Log₁₀ Reduction”) at a log₁₀ reduction of 1.48 (i.e., AntiLog₁₀ value of 30.20). The “Observed Average Reduction” of Antimicrobial Composition #2E at the AntiLog₁₀ value of 30.20 was substantially higher than the “Expected Reduction via Colby's Calculation” at the AntiLog₁₀ value of 23.62. Therefore, there was a synergistic effect between PAA and acetic acid in Composition #2E.

Similarly, as shown in TABLE 2, there was a synergistic effect between PAA and valeric acid in Antimicrobial Composition #2G, when compared to Antimicrobial Composition #2A (containing PAA as the sole antimicrobial compound) and Antimicrobial Composition #2F contained valeric acid as a sole antimicrobial compound).

There was a synergistic effect between PAA and caproic acid in Antimicrobial Composition #2J, when compared to Antimicrobial Composition #2A (containing PAA as the sole antimicrobial compound) and Antimicrobial Composition #2H contained caproic acid as a sole antimicrobial compound).

There was a synergistic effect between PAA and caprylic acid in Antimicrobial Composition #2L, when compared to Antimicrobial Composition #2A (containing PAA as the sole antimicrobial compound) and Antimicrobial Composition #2K contained caprylic acid as a sole antimicrobial compound).

Furthermore, there was a synergistic effect between PAA and lauric acid in Antimicrobial Composition #2N, when compared to Antimicrobial Composition #2A (containing PAA as the sole antimicrobial compound) and Antimicrobial Composition #2M contained lauric acid as a sole antimicrobial compound).

TABLE 2

| | #2A | #2B | #2C | #2D | #2E | #2F | #2G |
|---|---|---|---|---|---|---|---|
| Peracetic acid (PAA) | 0.025% | — | 0.025% | — | 0.025% | — | 0.025% |
| Formic acid | — | 2.55% | 2.55% | — | — | — | — |
| Acetic acid | — | — | — | 2.55% | 2.55% | — | — |
| Valeric acid | — | — | — | — | — | 2.55% | 2.55% |
| Caproic acid | — | — | — | — | — | — | — |
| Caprylic acid | — | — | — | — | — | — | — |
| Lauric acid | — | — | — | — | — | — | — |
| Anionic Surfactant | — | 0.28% | 0.28% | 0.28% | 0.28% | 0.28% | 0.28% |
| Nonionic Surfactant | — | 0.70% | 0.70% | 0.70% | 0.70% | 0.70% | 0.70% |
| Water | q.s. to | q.s. to | q.s. to | q.s. to | q.s. to | q.s. to | q.s. to |
| (including pH | 100% | 100% | 100% | 100% | 100% | 100% | 100% |
| Adjusting Agent) | | | | | | | |
| Microefficiency against | | | | | | | |
| Salmonella Enterica | | | | | | | |
| Observed | 1.16 | 1.74 | 2.16 | 1.03 | 1.48 | 1.20 | 1.51 |
| Aver. Log₁₀ | | | | | | | |
| Reduction | | | | | | | |
| Observed Average | 10^{1.16} = | 10^{1.74} = | 10^{2.16} = | 10^{1.03} = | 10^{1.48} = | 10^{1.20} = | 10^{1.51} = |
| Reduction | 14.45 | 54.95 | 144.54 | 10.72 | 30.20 | 15.85 | 32.36 |
| (AntiLog₁₀ value) | | | | | | | |
| Expected Reduction | — | — | 61.46 | — | 23.62 | — | 28.01 |
| via Colby's | | | | | | | |
| Calculation | | | | | | | |
| (AntiLog₁₀ value) | | | | | | | |

| | #2H | #2J | #2K | #2L | #2M | #2N |
|---|---|---|---|---|---|---|
| Peracetic acid (PAA) | — | 0.025% | — | 0.025% | — | 0.025% |
| Formic acid | — | — | — | — | — | — |
| Acetic acid | — | — | — | — | — | — |
| Valeric acid | — | — | — | — | — | — |
| Caproic acid | 2.55% | 2.55% | — | — | — | — |
| Caprylic acid | — | — | 2.55% | 2.55% | — | — |
| Lauric acid | — | — | — | — | 2.55% | 2.55% |
| Anionic Surfactant | 0.28% | 0.28% | 0.28% | 0.28% | 0.28% | 0.28% |
| Nonionic Surfactant | 0.70% | 0.70% | 0.70% | 0.70% | 0.70% | 0.70% |
| Water | q.s. to | q.s. to | q.s. to | q.s. to | q.s. to | q.s. to |
| (including pH | 100% | 100% | 100% | 100% | 100% | 100% |
| Adjusting Agent) | | | | | | |
| Microefficiency against | | | | | | |
| Salmonella Enterica | | | | | | |
| Observed | 1.04 | 1.70 | 1.40 | 1.80 | 0.92 | 1.38 |
| Aver. Log₁₀ | | | | | | |
| Reduction | | | | | | |
| Observed Average | 10^{1.04} = | 10^{1.20} = | 10^{1.40} = | 10^{1.80} = | 10^{0.92} = | 10^{1.38} = |
| Reduction | 10.96 | 50.12 | 25.12 | 63.10 | 8.32 | 23.99 |
| (AntiLog₁₀ value) | | | | | | |
| Expected Reduction | — | 23.83 | — | 35.49 | — | 21.57 |
| via Colby's | | | | | | |
| Calculation | | | | | | |
| (AntiLog₁₀ value) | | | | | | |

### Example 3

TABLE 3 showed the antimicrobial efficacy of the antimicrobial compositions against Salmonella Enterica ATCC 10708 to demonstrate the synergistic effect between peracetic acid (PAA) and various carboxylic acids containing at least one carboxylic acid group and at least one hydroxyl group. The tested carboxylic acids were glycolic acid, lactic acid, citric acid, malic acid, tartaric acid, and salicylic acid. The concentration of PAA was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

Antimicrobial Composition #3A, which contained PAA as the sole antimicrobial compound, provided an antimicrobial efficacy against Salmonella Enterica at a log₁₀ reduction of 1.16 (i.e., AntiLog₁₀ value of 14.45). Antimicrobial Composition #3B, which contained glycolic acid as an antimicrobial compound, provided a log₁₀ reduction of 1.23 (i.e., AntiLog₁₀ value of 16.98).

Antimicrobial Composition #3C, which was essentially the combination of Antimicrobial Compositions #3A and #3B, contained both PAA and glycolic acid as antimicrobial compounds. Antimicrobial Composition #3C provided the antimicrobial efficiency (“Observed Average Log₁₀ Reduction”) at a log₁₀ reduction of 1.91 (i.e., AntiLog₁₀ value of 81.28). The “Observed Average Reduction” of Antimicrobial Composition #2C at the AntiLog₁₀ value of 81.28 was substantially higher than the “Expected Reduction via Colby's Calculation” at the AntiLog₁₀ value of 28.98. Therefore, there was a synergistic effect between PAA and glycolic acid in Composition #3C.

TABLE 3 also showed that there was a synergistic effect between PAA and lactic acid in Antimicrobial Composition #3E, when compared to Antimicrobial Composition #3A (containing PAA as the sole antimicrobial compound) and Antimicrobial Composition #2D contained lactic acid as a sole antimicrobial compound).

Furthermore, TABLE 3 showed that there were a synergistic effect between PAA and citric acid in Antimicrobial Composition #3G, a synergistic effect between PAA and malic acid in Antimicrobial Composition #3J, a synergistic effect between PAA and tartaric acid in Antimicrobial Composition #3L, and a synergistic effect between PAA and salicylic acid in Antimicrobial Composition #3N.

TABLE 3

| | #3A | #3B | #3C | #3D | #3E | #3F | #3G |
|---|---|---|---|---|---|---|---|
| Peraceti acid | 0.025% | — | 0.025% | — | 0.025% | — | 0.025% |
| Glycolic acid | — | 2.55% | 2.55% | — | — | — | — |
| Lactic acid | — | — | — | 2.55% | 2.55% | — | — |
| Citric acid | — | — | — | — | — | 2.55% | 2.55% |
| Malic acid | — | — | — | — | — | — | — |
| Tartaric acid | — | — | — | — | — | — | — |
| Salicylic acid | — | — | — | — | — | — | — |
| Anionic Surfactant | — | 0.28% | 0.28% | 0.28% | 0.28% | 0.28% | 0.28% |
| Nonionic Surfactant | — | 0.70% | 0.70% | 0.70% | 0.70% | 0.70% | 0.70% |
| Water | q.s. to | q.s. to | q.s. to | q.s. to | q.s. to | q.s. to | q.s. to |
| (including pH | 100% | 100% | 100% | 100% | 100% | 100% | 100% |
| Adjusting Agent) | | | | | | | |
| Microefficiency against | | | | | | | |
| Salmonella Enterica | | | | | | | |
| Observed | 1.16 | 1.23 | 1.91 | 1.28 | 1.59 | 1.40 | 1.80 |
| Aver. Log₁₀ | | | | | | | |
| Reduction | | | | | | | |
| Observed Average | 10^{1.16} = | 10^{1.23} = | 10^{1.91} = | 10^{1.28} = | 10^{1.59} = | 10^{1.40} = | 10^{1.80} = |
| Reduction | 14.45 | 16.98 | 81.28 | 19.05 | 38.90 | 25.11 | 63.10 |
| (AntiLog₁₀ value) | | | | | | | |
| Expected Reduction | — | — | 28.98 | — | 31.13 | — | 35.93 |
| via Colby's | | | | | | | |
| Calculation | | | | | | | |
| (AntiLog₁₀ value) | | | | | | | |

| | #3H | #3J | #3K | #3L | #3M | #3N |
|---|---|---|---|---|---|---|
| Peraceti acid | — | 0.025% | — | 0.025% | — | 0.025% |
| Glycolic acid | — | — | — | — | — | — |
| Lactic acid | — | — | — | — | — | — |
| Citric acid | — | — | — | — | — | — |
| Malic acid | 2.55% | 2.55% | — | — | — | — |
| Tartaric acid | — | — | 2.55% | 2.55% | — | — |
| Salicylic acid | — | — | — | — | 2.55% | 2.55% |
| Anionic Surfactant | 0.28% | 0.28% | 0.28% | 0.28% | 0.28% | 0.28% |
| Nonionic Surfactant | 0.70% | 0.70% | 0.70% | 0.70% | 0.70% | 0.70% |
| Water | q.s. to | q.s. to | q.s. to | q.s. to | q.s. to | q.s. to |
| (including pH | 100% | 100% | 100% | 100% | 100% | 100% |
| Adjusting Agent) | | | | | | |
| Microefficiency against | | | | | | |
| Salmonella Enterica | | | | | | |
| Observed | 1.30 | 1.62 | 1.23 | 1.55 | 1.30 | 1.63 |
| Aver. Log₁₀ | | | | | | |
| Reduction | | | | | | |
| Observed Average | 10^{1.30} = | 10^{1.62} = | 10^{1.23} = | 10^{1.55} = | 10^{1.30} = | 10^{1.63} = |
| Reduction | 19.95 | 41.69 | 16.98 | 35.48 | 19.95 | 42.66 |
| (AntiLog₁₀ value) | | | | | | |
| Expected Reduction | — | 31.52 | — | 28.98 | — | 31.52 |
| via Colby's | | | | | | |
| Calculation | | | | | | |
| (AntiLog₁₀ value) | | | | | | |

### Example 4

TABLE 4 showed the antimicrobial efficacy of the tested antimicrobial compositions against Salmonella Enterica ATCC 10708 to demonstrate the synergistic effect between peracetic acid and various carboxylic acids containing more than one carboxylic acid groups. The tested carboxylic acids were succinic acid, adipic acid, itaconic acid, benzoic acid, and oxalic acid. The concentration of PAA was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

Antimicrobial Composition #4A, which contained PAA as the sole antimicrobial compound, provided an antimicrobial efficacy against Salmonella Enterica at a log₁₀ reduction of 1.16 (i.e., AntiLog₁₀ value of 14.45). Antimicrobial Composition #4B, which contained succinic acid as an antimicrobial compound, provided a log₁₀ reduction of 1.35 (i.e., AntiLog₁₀ value of 22.39).

Antimicrobial Composition #4C, which was essentially the combination of Antimicrobial Compositions #4A and #4B, contained both PAA and succinic acid as antimicrobial compounds. Antimicrobial Composition #4C provided the antimicrobial efficiency (“Observed Average Log₁₀ Reduction”) at a log₁₀ reduction of 1.72 (i.e., AntiLog₁₀ value of 52.48). The “Observed Average Reduction” of Antimicrobial Composition #4C at the AntiLog₁₀ value of 52.48 was substantially higher than the “Expected Reduction via Colby's Calculation” at the AntiLog₁₀ value of 33.60. Therefore, there was a synergistic effect between PAA and succinic acid in Composition #4C.

TABLE 4 also showed that there was a synergistic effect between PAA and adipic acid in Antimicrobial Composition #4E, when compared to Antimicrobial Composition #4A (containing PAA as the sole antimicrobial compound) and Antimicrobial Composition #4D contained adipic acid as a sole antimicrobial compound).

Furthermore, TABLE 4 showed that there were a synergistic effect between PAA and itaconic acid in Antimicrobial Composition #4G, a synergistic effect between PAA and benzoic acid in Antimicrobial Composition #4J, and a synergistic effect between PAA and oxalic acid in Antimicrobial Composition #4L.

TABLE 4

| | #4A | #4B | #4C | #4D | #4E | #4F | #4G | #4H | #4J | #4K | #4L |
|---|---|---|---|---|---|---|---|---|---|---|---|
| Peracetic acid | 0.025% | — | 0.025% | — | 0.025% | — | 0.025% | — | 0.025% | — | 0.025% |
| Succinic acid | — | 2.55% | 2.55% | — | — | — | — | — | — | — | — |
| Adipic acid | — | — | — | 2.55% | 2.55% | — | — | — | — | — | — |
| Itaconic acid | — | — | — | — | — | 2.55% | 2.55% | — | — | — | — |
| Benzoic acid | — | — | — | — | — | — | — | 2.55% | 2.55% | — | — |
| Oxalic acid | — | — | — | — | — | — | — | — | — | 2.55% | 2.55% |
| Anionic Surfactant | — | 0.28% | 0.28% | 0.28% | 0.28% | 0.28% | 0.28% | 0.28% | 0.28% | 0.28% | 0.28% |
| Nonionic Surfactant | | 0.70% | 0.70% | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% | 100% | 100% |
| Microefficiency against | | | | | | | | | | | |
| Salmonella Enterica | | | | | | | | | | | |
| Observed Aver. | 1.16 | 1.35 | 1.72 | 1.31 | 1.77 | 1.15 | 1.53 | 1.17 | 1.45 | 1.32 | 1.55 |
| Log₁₀ Reduction | | | | | | | | | | | |
| Observed Average | 10^{1.16} = | 10^{1.35} = | 10^{1.72} = | 10^{1.31} = | 10^{1.77} = | 10^{1.15} = | 10^{1.53} = | 10^{1.17} = | 10^{1.45} = | 10^{1.32} = | 10^{1.55} = |
| Reduction | 14.45 | 22.39 | 52.48 | 20.41 | 58.88 | 14.13 | 33.88 | 14.79 | 28.18 | 20.89 | 35.48 |
| (AntiLog₁₀ value) | | | | | | | | | | | |
| Expected Reduction | — | — | 33.60 | — | 31.91 | — | 26.54 | — | 27.10 | — | 32.32 |
| via Colby's | | | | | | | | | | | |
| Calculation | | | | | | | | | | | |
| (AntiLog₁₀ value) | | | | | | | | | | | |

### Example 5

TABLES 5 and 6 showed the antimicrobial efficacy of the tested antimicrobial compositions against Salmonella Enterica ATCC 10708 to demonstrate the synergistic effect between perglycolic acid and various carboxylic acids. The tested carboxylic acids in TABLE 5 were formic acid, propionic acid, and caprylic acid. The tested carboxylic acids in TABLE 6 were oxalic acid, lactic acid, succinic acid, and itaconic acid.

The concentration of PAA was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

TABLE 5 showed that Antimicrobial Composition #5A, which contained perglycolic acid as the sole antimicrobial compound, provided an antimicrobial efficacy against Salmonella Enterica at a log₁₀ reduction of 1.13 (i.e., AntiLog₁₀ value of 13.49). Antimicrobial Composition #5B, which contained formic acid as an antimicrobial compound, provided a log₁₀ reduction of 1.75 (i.e., AntiLog₁₀ value of 56.23).

Antimicrobial Composition #5C, which was essentially the combination of Antimicrobial Compositions #5A and #5B, contained both perglycolic acid and formic acid as antimicrobial compounds. Antimicrobial Composition #5C provided the antimicrobial efficiency (“Observed Average Log₁₀ Reduction”) at a log₁₀ reduction of 2.00 (i.e., AntiLog₁₀ value of 100.00). The “Observed Average Reduction” of Antimicrobial Composition #5C at the AntiLog₁₀ value of 100.00 was higher than the “Expected Reduction via Colby's Calculation” at the AntiLog₁₀ value of 62.13. Therefore, there was a synergistic effect between perglycolic acid and formic acid in Composition #5C.

Furthermore, TABLE 5 showed that there were a synergistic effect between perglycolic acid and propionic acid in Antimicrobial Composition #5E, and a synergistic effect between perglycolic acid and caprylic acid in Antimicrobial Composition #5G.

TABLE 6 showed that Antimicrobial Composition #6A, which contained perglycolic acid as the sole antimicrobial compound, provided an antimicrobial efficacy against Salmonella Enterica at a log₁₀ reduction of 1.13 (i.e., AntiLog₁₀ value of 13.49). Antimicrobial Composition #6B, which contained oxalic acid as an antimicrobial compound, provided a log₁₀ reduction of 1.32 (i.e., AntiLog₁₀ value of 20.89).

Antimicrobial Composition #6C, which was essentially the combination of Antimicrobial Compositions #6A and #6B, contained both perglycolic acid and oxalic acid as antimicrobial compounds. Antimicrobial Composition #6C provided the antimicrobial efficiency (“Observed Average Log₁₀ Reduction”) at a log₁₀ reduction of 1.58 (i.e., AntiLog₁₀ value of 38.02). The “Observed Average Reduction” of Antimicrobial Composition #5C at the AntiLog₁₀ value of 38.02 was higher than the “Expected Reduction via Colby's Calculation” at the AntiLog₁₀ value of 31.56. Therefore, there was a synergistic effect between perglycolic acid and oxalic acid in Composition #6C.

Furthermore, TABLE 6 showed that there were a synergistic effect between perglycolic acid and lactic acid in Antimicrobial Composition #6E, a synergistic effect between perglycolic acid and succinic acid in Antimicrobial Composition #6G, and a synergistic effect between perglycolic acid and itaconic acid in Antimicrobial Composition #6J.

TABLE 5

| | #5A | #5B | #5C | #5D | #5E | #5F | #5G |
|---|---|---|---|---|---|---|---|
| Perglycolic acid | 0.025% | — | 0.025% | — | 0.025% | — | 0.025% |
| Formic acid | — | 2.55% | 2.55% | — | — | — | — |
| Propionic acid | — | — | — | 2.55% | 2.55% | — | — |
| Caprylic acid | — | — | — | — | — | 2.55% | 2.55% |
| Anionic Surfactant | — | 0.28% | 0.28% | 0.28% | 0.28% | 0.28% | 0.28% |
| Nonionic Surfactant | — | 0.70% | 0.70% | 0.70% | 0.70% | 0.70% | 0.70% |
| Water (including pH | q.s. to | q.s. to | q.s. to | q.s. to | q.s. to | q.s. to | q.s. to |
| Adjusting Agent) | 100% | 100% | 100% | 100% | 100% | 100% | 100% |
| Microefficiency against | | | | | | | |
| Salmonella Enterica | | | | | | | |
| Observed Average | 1.13 | 1.75 | 2.00 | 0.79 | 1.51 | 1.40 | 1.79 |
| Log₁₀ Reduction | | | | | | | |
| Observed Average Reduction | 10^{1.13} = | 10^{1.75} = | 10^{2.00} = | 10^{0.79} = | 10^{1.51} = | 10^{1.40} = | 10^{1.79} = |
| (AntiLog₁₀ value) | 13.49 | 56.23 | 100.00 | 6.17 | 32.36 | 25.12 | 61.66 |
| Expected Reduction via | — | — | 62.13 | — | 18.83 | — | 35.22 |
| Colby's Calculation | | | | | | | |
| (AntiLog₁₀ value) | | | | | | | |

TABLE 6

| | #6A | #6B | #6C | #6D | #6E | #6F | #6G | #6H | #6J |
|---|---|---|---|---|---|---|---|---|---|
| Perglycolic acid | 0.025% | — | 0.025% | — | 0.025% | — | 0.025% | — | 0.025% |
| Oxalic acid | — | 2.55% | 2.55% | — | — | — | — | — | — |
| Lactic acid | — | — | — | 2.55% | 2.55% | — | — | — | — |
| Succinic acid | — | — | — | — | — | 2.55% | 2.55% | — | — |
| Itaconic acid | — | — | — | — | — | — | — | 2.55% | 2.55% |
| Anionic Surfactant | — | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. | 1.13 | 1.32 | 1.58 | 1.28 | 1.55 | 1.35 | 1.57 | 1.15 | 1.48 |
| Log₁₀ Reduction | | | | | | | | | |
| Observed Average | 10^{1.13} = | 10^{1.32} = | 10^{1.58} = | 10^{1.28} = | 10^{1.55} = | 10^{1.35} = | 10^{1.57} = | 10^{1.15} = | 10^{1.48} = |
| Reduction | 13.49 | 20.89 | 38.02 | 19.05 | 35.48 | 22.39 | 37.15 | 14.13 | 30.20 |
| (AntiLog₁₀ value) | | | | | | | | | |
| Expected Reduction | — | — | 31.56 | — | 29.97 | — | 32.86 | — | 25.71 |
| via Colby's | | | | | | | | | |
| Calculation | | | | | | | | | |
| (AntiLog₁₀ value) | | | | | | | | | |

### Example 6

TABLES 7 and 8 showed the antimicrobial efficacy of the tested antimicrobial compositions against Salmonella Enterica ATCC 10708 to demonstrate the synergistic effect between performic acid and various carboxylic acids. The tested carboxylic acids in TABLE 7 were caprylic acid, lauric acid, acetic acid, and benzoic acid. The tested carboxylic acids in TABLE 8 were salicylic acid, lactic acid, malic acid, succinic acid, and itaconic acid.

The concentration of PAA was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

TABLE 7 showed that Antimicrobial Composition #7A, which contained performic acid as the sole antimicrobial compound, provided an antimicrobial efficacy against Salmonella Enterica at a log₁₀ reduction of 0.92 (i.e., AntiLog₁₀ value of 8.32). Antimicrobial Composition #7B, which contained caprylic acid as an antimicrobial compound, provided a log₁₀ reduction of 1.40 (i.e., AntiLog₁₀ value of 25.12).

Antimicrobial Composition #7C, which was essentially the combination of Antimicrobial Compositions #7A and #7B, contained both performic acid and caprylic acid as antimicrobial compounds. Antimicrobial Composition #7C provided the antimicrobial efficiency (“Observed Average Log₁₀ Reduction”) at a log₁₀ reduction of 1.86 (i.e., AntiLog₁₀ value of 72.44). The “Observed Average Reduction” of Antimicrobial Composition #7C at the AntiLog₁₀ value of 72.44 was substantially higher than the “Expected Reduction via Colby's Calculation” at the AntiLog₁₀ value of 31.35. Therefore, there was a synergistic effect between perglycolic acid and formic acid in Composition #7C.

Furthermore, TABLE 7 showed that there were a synergistic effect between performic acid and lauric acid in Antimicrobial Composition #7E, a synergistic effect between performic acid and acetic acid in Antimicrobial Composition #7G, and a synergistic effect between performic acid and benzoic acid in Antimicrobial Composition #7J.

TABLE 8 showed that Antimicrobial Composition #8A, which contained performic acid as the sole antimicrobial compound, provided an antimicrobial efficacy against Salmonella Enterica at a log₁₀ reduction of 0.92 (i.e., AntiLog₁₀ value of 8.32). Antimicrobial Composition #8B, which contained salicylic acid as an antimicrobial compound, provided a log₁₀ reduction of 1.30 (i.e., AntiLog₁₀ value of 19.95).

Antimicrobial Composition #8C, which was essentially the combination of Antimicrobial Compositions #8A and #8B, contained both performic acid and salicylic acid as antimicrobial compounds. Antimicrobial Composition #8C provided the antimicrobial efficiency (“Observed Average Log₁₀ Reduction”) at a log₁₀ reduction of 1.90 (i.e., AntiLog₁₀ value of 79.43). The “Observed Average Reduction” of Antimicrobial Composition #8C at the AntiLog₁₀ value of 79.43 was higher than the “Expected Reduction via Colby's Calculation” at the AntiLog₁₀ value of 26.61. Therefore, there was a synergistic effect between perglycolic acid and oxalic acid in Composition #8C.

Furthermore, TABLE 8 showed that there were a synergistic effect between performic acid and lactic acid in Antimicrobial Composition #8E, a synergistic effect between performic acid and malic acid in Antimicrobial Composition #8G, a synergistic effect between performic acid and succinic acid in Antimicrobial Composition #8J, and a synergistic effect between performic acid and itaconic acid in Antimicrobial Composition #8L.

TABLE 7

| | #7A | #7B | #7C | #7D | #7E | #7F | #7G | #7H | #7J |
|---|---|---|---|---|---|---|---|---|---|
| Performic acid | 0.025% | — | 0.025% | — | 0.025% | — | 0.025% | — | 0.025% |
| Caprylic acid | — | 2.55% | 2.55% | — | — | — | — | — | — |
| Lauric acid | — | — | — | 2.55% | 2.55% | — | — | — | — |
| Acetic acid | — | — | — | — | — | 2.55% | 2.55% | — | — |
| Benzoic acid | — | — | — | — | — | — | — | 2.55% | 2.55% |
| Anionic Surfactant | — | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. | 0.92 | 1.40 | 1.86 | 0.92 | 1.48 | 1.75 | 1.83 | 1.17 | 1.48 |
| Log₁₀ Reduction | | | | | | | | | |
| Observed Average | 10^{0.92} = | 10^{1.40} = | 10^{1.86} = | 10^{0.92} = | 10^{1.48} = | 10^{1.75} = | 10^{1.83} = | 10^{1.17} = | 10^{1.48} = |
| Reduction | 8.32 | 25.12 | 72.44 | 8.32 | 30.20 | 56.23 | 67.61 | 14.79 | 30.20 |
| (AntiLog₁₀ value) | | | | | | | | | |
| Expected Reduction | — | — | 31.35 | — | 15.95 | — | 59.87 | — | 21.88 |
| via Colby's Calculation | | | | | | | | | |
| (AntiLog₁₀ value) | | | | | | | | | |

TABLE 8

| | #8A | #8B | #8C | #8D | #8E | #8F | #8G | #8H | #8J | #8K | #8L |
|---|---|---|---|---|---|---|---|---|---|---|---|
| Performic acid | 0.025% | — | 0.025% | — | 0.025% | — | 0.025% | — | 0.025% | — | 0.025% |
| Salicylic acid | — | 2.55% | 2.55% | — | — | — | — | — | — | — | — |
| Lactic acid | — | — | — | 2.55% | 2.55% | — | — | — | — | — | — |
| Malic acid | — | — | — | — | — | 2.55% | 2.55% | — | — | — | — |
| Succinic acid | — | — | — | — | — | — | — | 2.55% | 2.55% | — | — |
| Itaconic acid | — | — | — | — | — | — | — | — | — | 2.55% | 2.55% |
| Anionic Surfactant | — | 0.28% | 0.28% | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% | 100% | 100% |
| Microefficiency against | | | | | | | | | | | |
| Salmonella Enterica | | | | | | | | | | | |
| Observed Aver. | 0.92 | 1.30 | 1.90 | 1.28 | 1.70 | 1.30 | 1.54 | 1.35 | 1.65 | 1.15 | 1.46 |
| Log₁₀ Reduction | | | | | | | | | | | |
| Observed Average | 10^{0.92} = | 10^{1.30} = | 10^{1.90} = | 10^{1.28} = | 10^{1.70} = | 10^{1.30} = | 10^{1.54} = | 10^{1.35} = | 10^{1.65} = | 10^{1.15} = | 10^{1.46} = |
| Reduction | 8.32 | 19.95 | 79.43 | 19.05 | 50.12 | 19.95 | 34.67 | 22.39 | 44.67 | 14.13 | 28.84 |
| (AntiLog₁₀ value) | | | | | | | | | | | |
| Expected Reduction | — | — | 26.61 | — | 25.79 | — | 26.61 | — | 28.85 | — | 21.27 |
| via Colby's | | | | | | | | | | | |
| Calculation | | | | | | | | | | | |
| (AntiLog₁₀ value) | | | | | | | | | | | |

### Example 7

TABLE 9 showed the antimicrobial efficacy of the tested antimicrobial compositions against Salmonella Enterica ATCC 10708 to demonstrate the synergistic effect between percaprylic acid and various carboxylic acids. The tested carboxylic acids were formic acid, acetic acid, propionic acid, caproic acid, lauric acid, benzoic acid, salicylic acid, glycolic acid, and lactic acid. The concentration of percaprylic was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

Antimicrobial Composition #9A, which contained percaprylic acid as the sole antimicrobial compound, provided an antimicrobial efficacy against Salmonella Enterica at a log₁₀ reduction of 1.19 (i.e., AntiLog₁₀ value of 15.49). Antimicrobial Composition #9B, which contained formic acid as an antimicrobial compound, provided a log₁₀ reduction of 1.75 (i.e., AntiLog₁₀ value of 56.23).

Antimicrobial Composition #9C, which was essentially the combination of Antimicrobial Compositions #9A and #9B, contained both percaprylic acid and formic acid as antimicrobial compounds. Antimicrobial Composition #9C provided the antimicrobial efficiency (“Observed Average Log₁₀ Reduction”) at a log₁₀ reduction of 1.88 (i.e., AntiLog₁₀ value of 75.86). The “Observed Average Reduction” of Antimicrobial Composition #4C at the AntiLog₁₀ value of 75.86 was higher than the “Expected Reduction via Colby's Calculation” at the AntiLog₁₀ value of 63.01. Therefore, there was a synergistic effect between PAA and succinic acid in Composition #9C.

TABLE 9 also showed that there were a synergistic effect between percaprylic acid and acetic acid in Antimicrobial Composition #9E, a synergistic effect between percaprylic acid and propionic acid in Antimicrobial Composition #9G, a synergistic effect between percaprylic acid and caproic acid in Antimicrobial Composition #9J, and a synergistic effect between percaprylic acid and lauric acid in Antimicrobial Composition #9L.

Furthermore, TABLE 9 showed that there were a synergistic effect between percaprylic acid and benzoic acid in Antimicrobial Composition #9N, a synergistic effect between percaprylic acid and salicylic acid in Antimicrobial Composition #9Q, a synergistic effect between percaprylic acid and glycolic acid in Antimicrobial Composition #9S, and a synergistic effect between percaprylic acid and lactic acid in Antimicrobial Composition #9U.

TABLE 9

| | #9A | #9B | #9C | #9D | #9E | #9F | #9G | #9H | #9J | #9K | #9L |
|---|---|---|---|---|---|---|---|---|---|---|---|
| Percaprylic acid | 0.025% | — | 0.025% | — | 0.025% | — | 0.025% | — | 0.025% | — | 0.025% |
| Formic acid | — | 2.55% | 2.55% | — | — | — | — | — | — | — | — |
| Acetic acid | — | — | — | 2.55% | 2.55% | — | — | — | — | — | — |
| Propionic acid | — | — | — | — | — | 2.55% | 2.55% | — | — | — | — |
| Caproic acid | — | — | — | — | — | — | — | 2.55% | 2.55% | — | — |
| Lauric acid | — | — | — | — | — | — | — | — | — | 2.55% | 2.55% |
| Anionic Surfactant | — | 0.28% | 0.28% | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% | 100% | 100% |
| Microefficiency against | | | | | | | | | | | |
| Salmonella Enterica | | | | | | | | | | | |
| Observed Aver. | 1.19 | 1.75 | 1.88 | 1.03 | 1.81 | 0.79 | 1.73 | 1.04 | 1.57 | 0.92 | 1.72 |
| Log₁₀ Reduction | | | | | | | | | | | |
| Observed Average | 10^{1.19} = | 10^{1.75} = | 10^{1.88} = | 10^{1.03} = | 10^{1.81} = | 10^{0.79} = | 10^{1.73} = | 10^{1.04} = | 10^{1.57} = | 10^{0.92} = | 10^{1.72} = |
| Reduction | 15.49 | 56.23 | 75.86 | 10.72 | 64.57 | 6.17 | 53.70 | 10.96 | 37.15 | 8.32 | 52.48 |
| (AntiLog₁₀ value) | | | | | | | | | | | |
| Expected | — | — | 63.01 | — | 24.55 | — | 20.70 | — | 24.75 | — | 22.52 |
| Reduction | | | | | | | | | | | |
| via Colby's | | | | | | | | | | | |
| Calculation | | | | | | | | | | | |
| (AntiLog₁₀ value) | | | | | | | | | | | |

| | #9A | #9M | #9N | #9P | #9Q | #9R | #9S | #9T | #9U |
|---|---|---|---|---|---|---|---|---|---|
| Percaprylic acid | 0.025% | — | 0.025% | — | 0.025% | — | 0.025% | — | 0.025% |
| Benzoic acid | — | 2.55% | 2.55% | — | — | — | — | — | — |
| Salicylic acid | — | — | — | 2.55% | 2.55% | — | — | — | — |
| Glycolic acid | — | — | — | — | — | 2.55% | 2.55% | — | — |
| Lactic acid | — | — | — | — | — | — | — | 2.55% | 2.55% |
| Anionic Surfactant | — | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. | 1.19 | 1.17 | 1.60 | 1.30 | 1.59 | 1.23 | 1.58 | 1.28 | 1.71 |
| Log₁₀ Reduction | | | | | | | | | |
| Observed Average | 10^{1.19} = | 10^{1.75} = | 10^{1.88} = | 10^{0.79} = | 10^{1.73} = | 10^{1.23} = | 10^{1.58} = | 10^{1.28} = | 10^{1.71} = |
| Reduction | 15.49 | 56.23 | 75.86 | 6.17 | 53.70 | 16.98 | 38.02 | 19.05 | 51.29 |
| (AntiLog₁₀ value) | | | | | | | | | |
| Expected Reduction | — | — | 63.01 | — | 20.70 | — | 29.84 | — | 31.59 |
| via Colby's | | | | | | | | | |
| Calculation | | | | | | | | | |
| (AntiLog₁₀ value) | | | | | | | | | |

### Example 8

TABLE 10 showed the antimicrobial efficacy of the tested antimicrobial compositions against Salmonella Enterica ATCC 10708 to demonstrate the synergistic effect between percapric acid and various carboxylic acids. The tested carboxylic acids were formic acid, caprylic acid, lactic acid, and tartaric acid. The concentration of percaprylic was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

Antimicrobial Composition #10C, which was essentially the combination of Antimicrobial Compositions #10A and #10B, contained both percapric acid and formic acid as antimicrobial compounds. Antimicrobial Composition #10C provided the antimicrobial efficiency (“Observed Average Log₁₀ Reduction”) at a log₁₀ reduction of 1.86 (i.e., AntiLog₁₀ value of 72.44). The “Observed Average Reduction” of Antimicrobial Composition #10C at the AntiLog₁₀ value of 72.44 was higher than the “Expected Reduction via Colby's Calculation” at the AntiLog₁₀ value of 61.03. Therefore, there was a synergistic effect between percapric acid and formic acid in Composition #10C.

Furthermore, TABLE 10 also showed that there were a synergistic effect between percapric acid and caprylic acid in Antimicrobial Composition #10E, a synergistic effect between percapric acid and lactic acid in Antimicrobial Composition #10G, and a synergistic effect between percapric acid and tartaric acid in Antimicrobial Composition #10J.

TABLE 10

| | #10A | #10B | #10C | #10D | #10E | #10F | #10G | #10H | #10J |
|---|---|---|---|---|---|---|---|---|---|
| Percapric acid | 0.025% | — | 0.025% | — | 0.025% | — | 0.025% | — | 0.025% |
| Formic acid | — | 2.55% | 2.55% | — | — | — | — | — | — |
| Caprylic acid | — | — | — | 2.55% | 2.55% | — | — | — | — |
| Lactic acid | — | — | — | — | — | 2.55% | 2.55% | — | — |
| Tartaric acid | — | — | — | — | — | — | — | 2.55% | 2.55% |
| Anionic Surfactant | — | 0.28% | 0.28% | 0.28% | 0.28% | 0.28% | 0.28% | 0.28% | 0.28% |
| Nonionic Surfactant | — | 0.70% | 0.70% | 0.70% | 0.70% | 0.70% | 0.70% | 0.70% | 0.70% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. | 1.04 | 1.75 | 1.86 | 1.40 | 1.74 | 1.28 | 1.66 | 1.23 | 1.73 |
| Log₁₀ Reduction | | | | | | | | | |
| Observed Average | 10^{1.04} = | 10^{1.75} = | 10^{1.86} = | 10^{1.40} = | 10^{1.74} = | 10^{1.28} = | 10^{1.66} = | 10^{1.23} = | 10^{1.73} = |
| Reduction | 10.96 | 56.23 | 72.44 | 25.12 | 54.95 | 19.05 | 45.70 | 16.98 | 53.70 |
| (AntiLog₁₀ value) | | | | | | | | | |
| Expected Reduction | — | — | 61.03 | — | 33.33 | — | 27.92 | — | 26.08 |
| via Colby's | | | | | | | | | |
| Calculation | | | | | | | | | |
| (AntiLog₁₀ value) | | | | | | | | | |

### Example 9

TABLE 11 showed the antimicrobial efficacy of the tested antimicrobial compositions against Salmonella Enterica ATCC 10708 to demonstrate the synergistic effect between perlauric acid and various carboxylic acids. The tested carboxylic acids were formic acid, caprylic acid, glycolic acid, lactic acid, tartaric acid, and benzoic acid. The concentration of percaprylic was 0.025 wt % (250 ppm) based on total weight of the antimicrobial composition, and the concentration of tested carboxylic acid was 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

Antimicrobial Composition #11C, which was essentially the combination of Antimicrobial Compositions #11A and #11B, contained both perlauric acid and formic acid as antimicrobial compounds. Antimicrobial Composition #11C provided the antimicrobial efficiency (“Observed Average Log₁₀ Reduction”) at a log₁₀ reduction of 1.89 (i.e., AntiLog₁₀ value of 77.62). The “Observed Average Reduction” of Antimicrobial Composition #10C at the AntiLog₁₀ value of 77.62 was higher than the “Expected Reduction via Colby's Calculation” at the AntiLog₁₀ value of 61.14. Therefore, there was a synergistic effect between perlauric acid and formic acid in Composition #11C.

Furthermore, TABLE 11 also showed that there were a synergistic effect between perlauric acid and caprylic acid in Antimicrobial Composition #11E, a synergistic effect between perlauric acid and glycolic acid in Antimicrobial Composition #11G, a synergistic effect between perlauric acid and lactic acid in Antimicrobial Composition #11J, a synergistic effect between perlauric acid and tartaric acid in Antimicrobial Composition #11L, and a synergistic effect between perlauric acid and benzoic acid in Antimicrobial Composition #11N.

TABLE 11

| | #11A | #11B | #11C | #11D | #11E | #11F | #11G |
|---|---|---|---|---|---|---|---|
| Perlauric acid | 0.025% | — | 0.025% | — | 0.025% | — | 0.025% |
| Formic acid | — | 2.55% | 2.55% | — | — | — | — |
| Caprylic acid | — | — | — | 2.55% | 2.55% | — | — |
| Glycolic acid | — | — | — | — | — | 2.55% | 2.55% |
| Lactic acid | — | — | — | — | — | — | — |
| Tartaric acid | — | — | — | — | — | — | — |
| Benzoic acid | — | — | — | — | — | — | — |
| Anionic Surfactant | — | — | 0.28% | 0.28% | 0.28% | 0.28% | 0.28% |
| Nonionic Surfactant | — | — | 0.70% | 0.70% | 0.70% | 0.70% | 0.70% |
| Water (including pH | q.s. to | q.s. to | q.s. to | q.s. to | q.s. to | q.s. to | q.s. to |
| Adjusting Agent) | 100% | 100% | 100% | 100% | 100% | 100% | 100% |
| Microefficiency against | | | | | | | |
| Salmonella Enterica | | | | | | | |
| Observed Aver. | 1.05 | 1.75 | 1.89 | 1.40 | 1.63 | 1.23 | 1.61 |
| Log₁₀ Reduction | | | | | | | |
| Observed Average | 10^{1.05} = | 10^{1.75} = | 10^{1.89} = | 10^{1.40} = | 10^{1.63} = | 10^{1.23} = | 10^{1.61} = |
| Reduction | 11.22 | 56.23 | 77.62 | 25.12 | 42.66 | 16.98 | 40.74 |
| (AntiLog₁₀ value) | | | | | | | |
| Expected Reduction | — | — | 61.14 | — | 33.52 | — | 26.29 |
| via Colby's | | | | | | | |
| Calculation | | | | | | | |
| (AntiLog₁₀ value) | | | | | | | |

| | #11H | #11J | #11K | #11L | #11M | #11N |
|---|---|---|---|---|---|---|
| Perlauric acid | — | 0.025% | — | 0.025% | — | 0.025% |
| Formic acid | — | — | — | — | — | — |
| Caprylic acid | — | — | — | — | — | — |
| Glycolic acid | — | — | — | — | — | — |
| Lactic acid | 2.55% | 2.55% | — | — | — | — |
| Tartaric acid | — | — | 2.55% | 2.55% | — | — |
| Benzoic acid | — | — | — | — | 2.55% | 2.55% |
| Anionic Surfactant | 0.28% | 0.28% | 0.28% | 0.28% | 0.28% | 0.28% |
| Nonionic Surfactant | 0.70% | 0.70% | 0.70% | 0.70% | 0.70% | 0.70% |
| Water (including pH | q.s. to | q.s. to | q.s. to | q.s. to | q.s. to | q.s. to |
| Adjusting Agent) | 100% | 100% | 100% | 100% | 100% | 100% |
| Microefficiency against | | | | | | |
| Salmonella Enterica | | | | | | |
| Observed Aver. | 1.28 | 1.55 | 1.23 | 1.69 | 1.17 | 1.65 |
| Log₁₀ Reduction | | | | | | |
| Observed Average | 10^{1.28} = | 10^{1.55} = | 10^{1.23} = | 10^{1.69} = | 10^{1.17} = | 10^{1.65} = |
| Reduction | 19.05 | 35.48 | 16.98 | 48.98 | 14.79 | 44.67 |
| (AntiLog₁₀ value) | | | | | | |
| Expected Reduction | — | 28.13 | — | 26.29 | — | 24.35 |
| via Colby's | | | | | | |
| Calculation | | | | | | |
| (AntiLog₁₀ value) | | | | | | |

### Example 10

TABLE 12 demonstrated that anionic surfactant contributed to the synergistic effect, along with percarboxylic acid and carboxylic acid, in the antimicrobial composition.

The antimicrobial efficacy of the tested antimicrobial compositions against Salmonella Enterica ATCC 10708. Peracetic acid was used as the percarboxylic acid at a concentration of 0.025 wt % (250 ppm), and formic acid was used as the carboxylic acid at a concentration of 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

TABLE 12

| | #12A | #12B | #12C | #12D | #12E | #12F |
|---|---|---|---|---|---|---|
| Peracetic acid (PAA) | 0.025% | — | 0.025% | 0.025% | 0.025% | 0.025% |
| Formic Acid | — | 2.55% | 2.55% | 2.55% | 2.55% | 2.55% |
| Anionic Surfactant | — | — | — | 0.28% | — | — |
| Nonionic Surfactant | — | — | — | — | 0.70% | — |
| pH Adjusting Agent | — | — | — | — | — | YES |
| Water | q.s. to | q.s. to | q.s. to | q.s. to | q.s. to | q.s. to |
| | 100% | 100% | 100% | 100% | 100% | 100% |
| Microefficiency against | | | | | | |
| Salmonella Enterica | | | | | | |
| Observed Average | 1.18 | 1.22 | 1.91 | 2.09 | 1.76 | 1.88 |
| Log₁₀ Reduction | | | | | | |
| Observed Average | 10^{1.18} = | 10^{1.22} = | 10^{1.91} = | | | |
| Reduction | 15.14 | 16.60 | 81.28 | | | |
| (AntiLog₁₀ value) | | | | | | |
| Expected Reduction | — | — | 29.23 | | | |
| via Colby's Calculation | | | | | | |
| (AntiLog₁₀ value) | | | | | | |

Antimicrobial Composition #12C was essentially the combination of Antimicrobial Compositions #12A and #12B, contained both PAA and formic acid as antimicrobial compounds. Antimicrobial Composition #12C provided the antimicrobial efficiency (“Observed Average Log₁₀ Reduction”) at a log₁₀ reduction of 1.91 (i.e., AntiLog₁₀ value of 81.28). The “Observed Average Reduction” of Antimicrobial Composition #12C at the AntiLog₁₀ value of 81.28 was significantly higher than the “Expected Reduction via Colby's Calculation” at the AntiLog₁₀ value of 29.23. Therefore, there was a synergistic effect between PAA and formic acid in Antimicrobial Composition #12C.

Antimicrobial Composition #12D was Antimicrobial Composition #12C with a presence of anionic surfactant in the composition. Antimicrobial Composition #12D provided the Observed Average Log₁₀ Reduction”) at a log₁₀ reduction of 2.09 (i.e., AntiLog₁₀ value of 123.03), which was much higher than the Antimicrobial Composition #12C (i.e., the composition without anionic surfactant having AntiLog₁₀ value of 81.28). Therefore, anionic surfactant contributed to the synergistic effect, along with percarboxylic acid and carboxylic acid, in the antimicrobial composition.

Antimicrobial Composition #12E was Antimicrobial Composition #12C with a presence of nonionic surfactant in the composition. Antimicrobial Composition #12F was Antimicrobial Composition #12C with a presence of pH adjusting agent in the composition. As shown in TABLE 12, neither Antimicrobial Composition #12E nor #12F showed any considerable improvement in the antimicrobial efficacy compared to Antimicrobial Composition #12C. Therefore, neither nonionic surfactant nor pH adjusting agent contributed to the synergistic effect in the antimicrobial composition.

### Example 11

TABLE 13 showed the antimicrobial efficacy of the antimicrobial compositions against Salmonella Enterica ATCC 10708 to demonstrate the synergistic effect between peracetic acid (PAA) and formic acid using different types of anionic surfactants. The tested anionic surfactants were sodium octyl sulfonate (“Sulfonate” surfactant), sodium lauryl sarcosinate (“Sarcosinate” surfactant), sodium octyl sulfosuccinate (“Sulfosuccinate” surfactant), capryleth-9-carboxylic acid (“Carboxylate” surfactant), phosphate ester of natural fatty acid (“Phosphate Ester” surfactant), and sodium lauryl sulfate (“Sulfate” surfactant). The concentration of PAA was 0.025 wt % (250 ppm) based on total weight of the antimicrobial composition, the concentration of tested carboxylic acid was 2.55 wt % based on total weight of the antimicrobial composition. Alkyl polyglucoside was used as a nonionic surfactant. The tested antimicrobial compositions had pH of from about 1.0 to about 3.0, and methane sulfonic acid was used as a pH adjusting acid to achieve the desired pH value.

As shown in TABLE 13, there was synergistic effect between peracetic acid (PAA) and formic acid regardless the types of anionic surfactants being used in the tested antimicrobial compositions.

TABLE 13

| | #13A | #13B | #13C | #13D | #13E | #13F | #13G |
|---|---|---|---|---|---|---|---|
| Peracetic acid | 0.025% | — | 0.025% | — | 0.025% | — | 0.025% |
| Formic acid | — | 2.55% | 2.55% | 2.55% | 2.55% | 2.55% | 2.55% |
| Sulfonate | — | 1.00% | 1.00% | — | — | — | — |
| Sarcosinate | — | — | — | 0.28% | 0.28% | — | — |
| Sulfosuccinate | — | — | — | — | — | 0.50% | 0.50% |
| Carboxylate | — | — | — | — | — | — | — |
| Phosphate Ester | — | — | — | — | — | — | — |
| Sulfate | | | | | | | |
| Nonionic | — | 0.70% | 0.70% | 0.70% | 0.70% | 0.70% | 0.70% |
| Surfactant | | | | | | | |
| Water (including pH | q.s. to | q.s. to | q.s. to | q.s. to | q.s. to | q.s. to | q.s. to |
| Adjusting Agent) | 100% | 100% | 100% | 100% | 100% | 100% | 100% |
| Microefficiency against | | | | | | | |
| Salmonella Enterica | | | | | | | |
| Observed Aver. | 1.16 | 1.60 | 2.12 | 1.56 | 1.99 | 1.64 | 1.99 |
| Log₁₀ Reduction | | | | | | | |
| Observed Average | 10^{1.16} = | 10^{1.60} = | 10^{2.12} = | 10^{0.56} = | 10^{1.99} = | 10^{1.64} = | 10^{1.99} = |
| Reduction | 14.45 | 39.81 | 131.82 | 36.31 | 97.72 | 43.65 | 97.72 |
| (AntiLog₁₀ value) | | | | | | | |
| Expected Reduction | — | — | 48.51 | — | 45.51 | — | 51.79 |
| via Colby's | | | | | | | |
| Calculation | | | | | | | |
| (AntiLog₁₀ value) | | | | | | | |

| | #13H | #13J | #13K | #13L | #13M | #13N |
|---|---|---|---|---|---|---|
| Peracetic acid | — | 0.025% | — | 0.025% | — | 0.025% |
| Formic acid | 2.55% | 2.55% | 2.55% | 2.55% | 2.55% | 2.55% |
| Sulfonate | — | — | — | — | — | — |
| Sarcosinate | — | — | — | — | — | — |
| Sulfosuccinate | — | — | — | — | — | — |
| Carboxylate | 0.70% | 0.70% | — | — | — | — |
| Phosphate Ester | — | — | 0.70% | 0.70% | — | — |
| Sulfate | | | | | 0.28% | 0.28% |
| Nonionic | 0.70% | 0.70% | 0.70% | 0.70% | 0.70% | 0.70% |
| Surfactant | | | | | | |
| Water (including pH | q.s. to | q.s. to | q.s. to | q.s. to | q.s. to | q.s. to |
| Adjusting Agent) | 100% | 100% | 100% | 100% | 100% | 100% |
| Microefficiency against | | | | | | |
| Salmonella Enterica | | | | | | |
| Observed Aver. | 1.59 | 1.98 | 1.58 | 2.00 | 1.74 | 2.16 |
| Log₁₀ Reduction | | | | | | |
| Observed Average | 10^{1.59} = | 10^{1.98} = | 10^{1.58} = | 10^{2.00} = | 10^{1.74} = | 10^{2.16} = |
| Reduction | 38.90 | 95.50 | 38.02 | 100.00 | 54.95 | 144.54 |
| (AntiLog₁₀ value) | | | | | | |
| Expected Reduction | — | 47.73 | — | 46.98 | — | 61.46 |
| via Colby's | | | | | | |
| Calculation | | | | | | |
| (AntiLog₁₀ value) | | | | | | |

### Example 12

TABLE 14 showed the synergistic effect between peracetic acid (PAA) and formic acid against Salmonella Enterica ATCC 10708 at various concentrations of PAA and at various weight ratios of PAA:formic acid in the tested antimicrobial compositions. Sodium lauryl sulfate was used as an anionic surfactant, and alkyl polyglucoside was used as a nonionic surfactant. The tested antimicrobial compositions had pH of from about 0.5 to about 3.0, and methane sulfonic acid was used as a pH adjusting acid to achieve the desired pH.

Antimicrobial Compositions #14A to #14C contained PAA at 0.008 wt % (80 ppm) and had a weight ratio of PAA:formic acid of 1:1. Antimicrobial Compositions #14D to #14T contained PAA at 0.01 wt % (100 ppm) at various weight ratios of PAA:formic acid. Antimicrobial Compositions #14AA to #14JJ contained PAA at 0.025 wt % (250 ppm) at various weight ratios of PAA:formic acid. Antimicrobial Compositions #14KK to #14PP contained PAA at 0.06 wt % (600 ppm) at various weight ratios of PAA:formic acid. Antimicrobial Compositions #14QQ to #14UU contained PAA at 0.20 wt % (2000 ppm) at various weight ratios of PAA:formic acid.

As shown in TABLE 14, the synergistic effect between peracetic acid (PAA) and formic acid at various concentrations of PAA and various weight ratios of PAA:formic acid.

TABLE 14

| | | | | Microefficiency against Salmonella Enterica | | |
|---|---|---|---|---|---|---|
| | | | | | | Expected |
| | | | | | Observed | Reduction |
| | Amount of | | Weight | Observed | Average | via Colby's |
| | Peracetic | Amount of | Ratio of | Average | Reduction | Calculation |
| Antimicrobial | Acid | Formic | PAA:formic | Log₁₀ | (AntiLog₁₀ | (AntiLog₁₀ |
| Composition | (PAA) | Acid | Acid | Reduction | value) | value) |
| #14A | 0.008% | — | — | 1.07 | 10^{1.07} = 11.75 | — |
| #14B | — | 0.008% | — | 0.49 | 10^{0.49} = 3.09 | — |
| #14C | 0.008% | 0.008% | 1:1 | 1.33 | 10^{1.33} = 21.38 | 14.48 |
| #14D | 0.01% | — | — | 1.10 | 10^{1.10} = 12.59 | — |
| #14E | — | 2.00% | — | 1.11 | 10^{1.11} = 12.88 | — |
| #14F | 0.01% | 2.00% | 0.005:1 | 1.70 | 10^{1.70} = 50.12 | 37.80 |
| #14G | — | 1.00% | — | 1.11 | 10^{1.11} = 12.88 | — |
| #14H | 0.01% | 1.00% | 0.01:1 | 1.62 | 10^{1.62} = 41.69 | 23.85 |
| #14J | — | 0.20% | — | 0.66 | 10^{0.66} = 4.57 | — |
| #14K | 0.01% | 0.20% | 0.05:1 | 1.60 | 10^{1.60} = 39.81 | 16.58 |
| #14L | — | 0.10% | — | 0.49 | 10^{0.49} = 3.09 | — |
| #14M | 0.01% | 0.10% | 0.10:1 | 1.33 | 10^{1.33} = 21.38 | 15.29 |
| #14N | — | 0.05% | — | 0.44 | 10^{0.44} = 2.75 | — |
| #14P | 0.01% | 0.05% | 0.20:1 | 1.29 | 10^{1.29} = 19.50 | 14.99 |
| #14Q | — | 0.025% | — | 0.51 | 10^{0.51} = 3.24 | — |
| #14R | 0.01% | 0.025% | 0.40:1 | 1.33 | 10^{1.31} = 20.42 | 15.42 |
| #14S | — | 0.015% | — | 0.53 | 10^{0.53} = 3.39 | — |
| #14T | 0.01% | 0.015% | 0.66:1 | 1.30 | 10^{1.30} = 19.95 | 15.55 |
| #14AA | 0.025% | — | — | 1.16 | 10^{1.16} = 14.45 | — |
| #14BB | — | 1.25% | — | 1.20 | 10^{1.20} = 15.85 | — |
| #14CC | 0.025% | 1.25% | 0.02:1 | 1.73 | 10^{1.73} = 53.70 | 28.01 |
| #14DD | — | 0.50% | — | 0.82 | 10^{0.82} = 6.61 | — |
| #14EE | 0.025% | 0.50% | 0.05:1 | 1.62 | 10^{1.62} = 41.69 | 20.10 |
| #14FF | — | 0.25% | — | 0.52 | 10^{0.52} = 3.31 | — |
| #14GG | 0.025% | 0.25% | 0.10:1 | 1.54 | 10^{1.54} = 34.67 | 17.28 |
| #14HH | — | 0.125% | | 0.70 | 10^{0.70} = 5.01 | |
| #14JJ | 0.025% | 0.125% | 0.20:1 | 1.40 | 10^{1.40} = 25.12 | 18.74 |
| #14KK | 0.06% | — | — | 1.30 | 10^{1.30} = 19.95 | — |
| #14LL | — | 0.30% | — | 0.55 | 10^{0.55} = 3.55 | — |
| #14MM | 0.06% | 0.30% | 0.20:1 | 1.62 | 10^{1.62} = 41.69 | 22.79 |
| #14NN | — | 0.24% | — | 0.70 | 10^{0.70} = 5.01 | — |
| #14PP | 0.06% | 0.24% | 0.20:1 | 1.60 | 10^{1.60} = 39.81 | 23.96 |
| #14QQ | 0.20% | — | — | 1.80 | 10^{1.80} = 63.10 | — |
| #14RR | — | 10% | — | 1.90 | 10^{1.90} = 79.43 | — |
| #14SS | 0.20% | 10% | 0.02:1 | 2.52 | 10^{2.52} = 331.13 | 92.41 |
| #14TT | — | 0.80% | | 1.09 | 10^{1.09} = 12.30 | |
| #14UU | 0.20% | 0.80% | 0.025:1 | 2.07 | 10^{2.07} = 117.50 | 67.64 |

### Example 13

TABLE 15 showed the synergistic effect between peracetic acid (PAA) and formic acid against other microbials beside Salmonella Enterica. The tested microbials were Listeria Monocytogenes, Escherichia coli, and Campylobacter Jejuni.

Peracetic acid (PAA) was used as the percarboxylic acid at a concentration of 0.025 wt % (250 ppm), and formic acid was used as the carboxylic acid at a concentration of 2.55 wt % based on total weight of the antimicrobial composition. Sodium lauryl sulfate was used as an anionic surfactant, and alkyl polyglucoside was used as a nonionic surfactant. The tested antimicrobial compositions had pH of from about 1.0 to about 3.0, and methane sulfonic acid was used as a pH adjusting acid to achieve the desired pH.

TABLE 15

| | #15A | #15B | #15C |
|---|---|---|---|
| Peracetic Acid (PAA) | 0.025% | — | 0.025% |
| Formic Acid | — | 2.55% | 2.55% |
| Anionic Surfactant | — | 0.28% | 0.28% |
| Nonionic Surfactant | — | 0.70% | 0.70% |
| Water (including pH adjusting agent) | q.s. to | q.s. to | q.s. to |
| | 100% | 100% | 100% |
| Microefficiency against Listeria | | | |
| Monocytogenes | | | |
| Observed Aver. Log₁₀ Reduction | 1.10 | 1.52 | 2.10 |
| Observed Average Reduction | 10^{1.10} = | 10^{1.52} = | 10^{2.10} = |
| (AntiLog₁₀ value) | 12.60 | 33.11 | 125.89 |
| Expected Reduction (AntiLog₁₀ value) | — | — | 41.54 |
| Microefficiency against Escherichia Coli | | | |
| Observed Aver. Log₁₀ Reduction | 1.10 | 1.44 | 2.02 |
| Observed Average Reduction | 10^{1.10} = | 10^{1.44} = | 10^{2.02} = |
| (AntiLog₁₀ value) | 12.60 | 27.54 | 104.71 |
| Expected Reduction (AntiLog₁₀ value) | — | — | 36.67 |
| Microefficiency against Campylobacter | | | |
| Jejuni | | | |
| Observed Aver. Log₁₀ Reduction | 0.92 | 1.58 | 2.15 |
| Observed Average Reduction | 10^{0.92} = | 10^{1.58} = | 10^{2.15} = |
| (AntiLog₁₀ value) | 8.32 | 38.02 | 141.25 |
| Expected Reduction (AntiLog₁₀ value) | — | — | 43.18 |

As shown in TABLE 15 above, Antimicrobial Composition #15C showed a synergistic effect between peracetic acid (PAA) and formic acid against the tested microbials: Listeria Monocytogenes, Escherichia coli, and Campylobacter Jejuni.

### Example 14

TABLE 16 showed the antimicrobial efficacy of the antimicrobial compositions against Salmonella Enterica ATCC 10708 to demonstrate the synergistic effect between cetyl pyridinium chloride (CPC) and various carboxylic acids. The tested carboxylic acids were malic acid, glycolic acid, gluconic acid, citric acid, tartaric acid, formic acid, succinic acid, itaconic acid, and propionic acid. The concentration of CPC was 0.80 wt % and the concentration of tested carboxylic acid was 3 wt % based on total weight of the antimicrobial composition. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

Antimicrobial Composition #16A, which contained CPC as the sole antimicrobial compound, provided an antimicrobial efficacy against Salmonella Enterica at a log₁₀ reduction of 0.74 (i.e., AntiLog₁₀ value of 5.50). Antimicrobial Composition #16B, which contained malic acid as an antimicrobial compound, provided a log₁₀ reduction of 0.87 (i.e., AntiLog₁₀ value of 7.41).

Antimicrobial Composition #16C, which was essentially the combination of Antimicrobial Compositions #16A and #16B, contained both CPC and malic acid as antimicrobial compounds. Antimicrobial Composition #16C provided the antimicrobial efficiency (“Observed Average Log₁₀ Reduction”) at a log₁₀ reduction of 1.40 (i.e., AntiLog₁₀ value of 25.12). The “Observed Average Reduction” of Antimicrobial Composition #16C at the AntiLog₁₀ value of 25.12 was higher than the “Expected Reduction via Colby's Calculation” at the AntiLog₁₀ value of 12.50. Therefore, there was a synergistic effect between CPC and malic acid in Composition #16C.

Furthermore, TABLE 16 showed that there were a synergistic effect between CPC and glycolic acid in Antimicrobial Composition #16E, a synergistic effect between CPC and gluconic acid in Antimicrobial Composition #16G, a synergistic effect between CPC and citric acid in Antimicrobial Composition #16J, a synergistic effect between CPC and tartaric acid in Antimicrobial Composition #16L, a synergistic effect between CPC and formic acid in Antimicrobial Composition #16N, a synergistic effect between CPC and succinic acid in Antimicrobial Composition #16Q, a synergistic effect between CPC and itaconic acid in Antimicrobial Composition #16S, and a synergistic effect between CPC and propionic acid in Antimicrobial Composition #16U.

TABLE 16

| | #16A | #16B | #16C | #16D | #16E | #16F | #16G | #16H | #16J | #16K | #16L |
|---|---|---|---|---|---|---|---|---|---|---|---|
| CPC | 0.8% | — | 0.8% | — | 0.8% | — | 0.8% | — | 0.8% | — | 0.8% |
| Malic acid | — | 3% | 3% | — | — | — | — | — | — | — | — |
| Glycolic acid | — | — | — | 3% | 3% | — | — | — | — | — | — |
| Gluconic acid | — | — | — | — | — | 3% | 3% | — | — | — | — |
| Citric acid | — | — | — | — | — | — | — | 3% | 3% | — | — |
| Tartaric acid | — | — | — | — | — | — | — | — | — | 3% | 3% |
| Organic Solvent | 1.2% | — | 1.2% | — | 1.2% | — | 1.2% | — | 1.2% | — | 1.2% |
| Water (including pH | q.s. to | q.s. to | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% | 100% | 100% |
| Microefficiency against | | | | | | | | | | | |
| Salmonella Enterica | | | | | | | | | | | |
| Observed Aver. | 0.74 | 0.87 | 1.40 | 0.96 | 1.60 | 0.30 | 1.03 | 1.14 | 1.50 | 1.06 | 1.34 |
| Log₁₀ Reduction | | | | | | | | | | | |
| Observed Average | 10^{0.74} = | 10^{0.87} = | 10^{1.40} = | 10^{0.96} = | 10^{1.60} = | 10^{0.30} = | 10^{1.03} = | 10^{1.14} = | 10^{1.50} = | 10^{1.06} = | 10^{1.34} = |
| Reduction | 5.50 | 7.41 | 25.12 | 9.12 | 39.81 | 2.00 | 10.72 | 13.80 | 31.62 | 11.48 | 21.88 |
| (AntiLog₁₀ value) | | | | | | | | | | | |
| Expected Reduction | — | — | 12.50 | — | 14.12 | — | 7.39 | — | 18.45 | — | 16.35 |
| via Colby's | | | | | | | | | | | |
| Calculation | | | | | | | | | | | |
| (AntiLog₁₀ value) | | | | | | | | | | | |

| | #16A | #16M | #16N | #16P | #16Q | #16R | #16S | #16T | #16U |
|---|---|---|---|---|---|---|---|---|---|
| CPC | 0.8% | — | 0.8% | — | 0.8% | — | 0.8% | — | 0.8% |
| Formic acid | — | 3% | 3% | — | — | — | — | — | — |
| Succinic acid | — | — | — | 3% | 3% | — | — | — | — |
| Itaconic acid | — | — | — | — | — | 3% | 3% | — | — |
| Propionic acid | — | — | — | — | — | — | — | 3% | 3% |
| Organic Solvent | 1.2% | — | 1.2% | — | 1.2% | — | 1.2% | — | 1.2% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. Log₁₀ Reduction | 0.74 | 1.07 | 1.54 | 1.17 | 1.60 | 0.89 | 1.30 | 1.20 | 1.50 |
| Observed Average Reduction | 10^{0.74} = | 10^{1.07} = | 10^{1.54} = | 10^{1.17} = | 10^{1.60} = | 10^{0.89} = | 10^{1.30} = | 10^{1.20} = | 10^{1.50} = |
| (AntiLog₁₀ value) | 5.01 | 11.75 | 34.67 | 14.79 | 39.81 | 7.76 | 19.95 | 15.85 | 31.62 |
| Expected Reduction via | — | — | 16.60 | — | 19.48 | — | 12.83 | — | 20.07 |
| Colby's Calculation | | | | | | | | | |
| (AntiLog₁₀ value) | | | | | | | | | |

### Example 15

TABLE 17 demonstrated that anionic surfactant, nonionic surfactant, and/or pH adjusting acid did not contribute to the synergistic effect against Salmonella Enterica ATCC 10708 for the antimicrobial compositions that comprise quaternary ammonium salt and carboxylic acid.

CPC was used as the quaternary ammonium salt at a concentration of 0.8 wt %, and lactic acid was used as the carboxylic acid at a concentration of 3 wt % based on total weight of the antimicrobial composition. Sodium octyl sulfonate was used as an anionic surfactant, and alkyl polyglucoside was used as a nonionic surfactant. Propylene glycol was used as an organic solvent to assist in the dispersion and stabilization of CPC in water; wherein propylene glycol by itself did not provide any antimicrobial efficiency. The tested antimicrobial compositions had pH of from about 1.0 to about 4.0, and methane sulfonic acid was used as a pH adjusting acid to achieve the desired pH.

TABLE 17

| | #17A | #17B | #17C | #17D | #17E |
|---|---|---|---|---|---|
| CPC | 0.8% | — | 0.8% | 0.8% | 0.8% |
| Lactic Acid | — | 3% | 3% | 3% | 3% |
| Anionic Surfactant | — | — | — | 1% | — |
| Nonionic Surfactant | — | — | — | 0.70% | — |
| Organic Solvent | 0.96% | — | 0.96% | 0.96% | 0.96% |
| pH Adjusting Agent | — | — | — | — | YES |
| Water | q.s. to | q.s. to | q.s. to | q.s. to | q.s. to |
| | 100% | 100% | 100% | 100% | 100% |
| Microefficiency | | | | | |
| against | | | | | |
| Salmonella Enterica | | | | | |
| Observed Average Log₁₀ | 0.70 | 1.12 | 1.55 | 1.58 | 1.53 |
| Reduction | | | | | |
| Observed Average | 10^{0.70} = | 10^{1.22} = | 10^{1.55} = | | |
| Reduction | 5.01 | 13.18 | 35.48 | | |
| (AntiLog₁₀ value) | | | | | |
| Expected Reduction via | — | — | 17.53 | | |
| Colby's Calculation | | | | | |
| (AntiLog₁₀ value) | | | | | |

Antimicrobial Composition #17C was essentially the combination of Antimicrobial Compositions #17A and #17B, contained both CPC and lactic acid as antimicrobial compounds. Antimicrobial Composition #17 provided the antimicrobial efficiency (“Observed Average Log₁₀ Reduction”) at a log₁₀ reduction of 1.55 (i.e., AntiLog₁₀ value of 35.48). The “Observed Average Reduction” of Antimicrobial Composition #17C at the AntiLog₁₀ value of 35.48 was significantly higher than the “Expected Reduction via Colby's Calculation” at the AntiLog₁₀ value of 17.53. Therefore, there was a synergistic effect between CPC and lactic acid in Antimicrobial Composition #17C.

Antimicrobial Composition #17D was Antimicrobial Composition #17C with the presence of anionic surfactant and nonionic surfactants in the composition. Antimicrobial Composition #17E was Antimicrobial Composition #17C with a presence of pH adjusting agent in the composition. As shown in TABLE 17, neither Antimicrobial Composition #17D nor #17E showed any considerable improvement in the antimicrobial efficacy compared to Antimicrobial Composition #17C. Therefore, anionic surfactant, nonionic surfactant, and/or pH adjusting agent did not contribute to the synergistic effect in the antimicrobial composition.

### Example 16

TABLE 18 showed the synergistic effect between CPC and lactic acid against Salmonella Enterica ATCC 10708, at various concentrations of CPC and various weight ratios of CPC:lactic acid in the tested antimicrobial compositions. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

Antimicrobial Compositions #18A to #18L contained CPC at 0.08 wt % at various weight ratios of CPC:lactic acid. Antimicrobial Compositions #18M to #18T contained CPC at 0.1 wt % at various weight ratios of CPC:lactic acid. Antimicrobial Compositions #18AA to #18CC contained CPC at 0.25 wt % at a CPC:lactic acid weight ratio of 1:3.75. Antimicrobial Compositions #18DD to #18RR contained CPC at 0.8 wt % at various weight ratios of CPC:lactic acid.

As shown in TABLE 18, the synergistic effect between CPC and lactic acid at various concentrations of CPC and various weight ratios of CPC:lactic acid.

TABLE 18

| | | | | Microefficiency against Salmonella Enterica | | |
|---|---|---|---|---|---|---|
| | | | | | | Expected |
| | | | | | Observed | Reduction |
| | | | Weight | Observed | Average | via Colby's |
| | | Amount of | Ratio of | Average | Reduction | Calculation |
| Antimicrobial | Amount of | Lactic | CPC:Lactic | Log₁₀ | (AntiLog₁₀ | (AntiLog₁₀ |
| Composition | CPC | Acid | Acid | Reduction | value) | value) |
| #18A | 0.08% | — | — | 0.29 | 10^{0.29} = 1.95 | — |
| #18B | — | 0.01% | — | 0.71 | 10^{0.71} = 5.13 | — |
| #18C | 0.08% | 0.01% | 1:0.125 | 0.92 | 10^{0.92} = 8.32 | 6.98 |
| #18D | — | 0.02% | — | 0.62 | 10^{0.62} = 4.17 | — |
| #18E | 0.08% | 0.02% | 1:0.25 | 0.89 | 10^{0.89} = 7.76 | 6.04 |
| #18F | — | 0.08% | — | 0.47 | 10^{0.47} = 2.95 | — |
| #18G | 0.08% | 0.08% | 1:1 | 0.73 | 10^{0.73} = 5.37 | 4.84 |
| #18H | — | 0.3% | — | 0.48 | 10^{0.48} = 3.01 | — |
| #18J | 0.08% | 0.3% | 1:3.75 | 0.79 | 10^{0.79} = 6.17 | 4.90 |
| #18K | — | 1.00% | — | 1.00 | 10^{1.00} = 10.00 | — |
| #18L | 0.08% | 1.00% | 1:12.5 | 1.26 | 10^{1.26} = 18.20 | 11.76 |
| #18M | 0.1% | — | — | 0.43 | 10^{0.43} = 2.69 | — |
| #18N | — | 0.05% | — | 0.38 | 10^{0.38} = 2.40 | — |
| #18P | 0.1% | 0.05% | 1:0.5 | 0.84 | 10^{0.84} = 6.92 | 5.83 |
| #18Q | — | 0.1% | — | 0.51 | 10^{0.51} = 3.23 | — |
| #18R | 0.1% | 0.1% | 1:1 | 0.90 | 10^{0.90} = 7.94 | 3.19 |
| #18S | — | 1% | — | 0.77 | 10^{0.77} = 5.89 | — |
| #18T | 0.1% | 1% | 1:10 | 1.06 | 10^{1.06} = 11.48 | 8.42 |
| #18AA | 0.25% | — | — | 0.56 | 10^{0.56} = 3.63 | — |
| #18BB | — | 0.94% | — | 0.73 | 10^{0.73} = 5.37 | — |
| #18CC | 0.25% | 0.94% | 1:3.75 | 1.28 | 10^{1.28} = 19.05 | 8.81 |
| #18DD | 0.8% | — | — | 0.70 | 10^{0.70} = 5.01 | — |
| #18EE | — | 0.008% | — | 0.28 | 10^{0.28} = 1.91 | — |
| #18FF | 0.8% | 0.008% | 1:0.01 | 1.10 | 10^{1.10} = 12.59 | 6.82 |
| #18GG | — | 0.01% | — | 0.78 | 10^{0.78} = 6.02 | — |
| #18HH | 0.8% | 0.01% | 1:0.0125 | 1.18 | 10^{1.18} = 15.14 | 10.73 |
| #18JJ | — | 0.1% | — | 0.51 | 10^{0.51} = 3.24 | — |
| #18KK | 0.8% | 0.1% | 1:0.125 | 1.18 | 10^{1.18} = 15.14 | 8.09 |
| #18LL | — | 0.1% | — | 0.86 | 10^{0.86} = 7.24 | — |
| #18MM | 0.8% | 0.4% | 1:0.5 | 1.17 | 10^{1.17} = 14.79 | 11.89 |
| #18NN | — | 3% | — | 1.27 | 10^{1.27} = 18.62 | — |
| #18PP | 0.8% | 3% | 1:10 | 1.51 | 10^{1.51} = 32.36 | 22.70 |
| #18QQ | — | 10% | — | 1.25 | 10^{1.25} = 17.78 | — |
| #18RR | 0.8% | 10% | 1:12.5 | 1.57 | 10^{1.57} = 37.15 | 21.90 |

### Example 17

TABLE 19 showed the antimicrobial efficacy of the antimicrobial compositions against Salmonella Enterica ATCC 10708 to demonstrate the synergistic effect between CPC and lactic acid in the presence of different anionic surfactants. The tested anionic surfactants were sodium octyl sulfonate (“Sulfonate” surfactant), sodium lauryl sarcosinate (“Sarcosinate” surfactant), and phosphate ester of natural fatty acid (“Phosphate Ester” surfactant).

The tested antimicrobial compositions contained CPC at 0.8 wt % and lactic acid at 3 wt % based on total weight of the composition. Propylene glycol was used as an organic solvent to assist in the dispersion and stabilization of CPC in water. Propylene glycol by itself did not provide any antimicrobial efficiency. Alkyl polyglucoside was used as a nonionic surfactant. The tested antimicrobial compositions had pH of from about 1.0 to about 4.0, and methane sulfonic acid was used as a pH adjusting acid to achieve the desired pH value.

As shown in TABLE 19, there was synergistic effect between CPC and lactic acid regardless the types of anionic surfactants being used in the tested antimicrobial compositions.

TABLE 19

| | #19A | #19B | #19C | #19D | #19E | #19F | #19G |
|---|---|---|---|---|---|---|---|
| CPC | 0.8% | — | 0.8% | — | 0.8% | — | 0.8% |
| Lactic Acid | — | 3% | 3% | 3% | 3% | 3% | 3% |
| Sulfonate Surfactant | — | 1.00% | 1.00% | — | — | — | — |
| Sarcosinate Surfactant | — | — | — | 0.28% | 0.28% | — | — |
| Phosphate Ester Surfactant | — | — | — | — | — | 1.00% | 1.00% |
| Nonionic Surfactant | — | 0.70% | 0.70% | 0.70% | 0.70% | 0.70% | 0.70% |
| Organic Solvent | 0.96% | 0.96% | 0.96% | 0.96% | 0.96% | 0.96% | 0.96% |
| Water (including pH | q.s. to | q.s. to | q.s. to | q.s. to | q.s. to | q.s. to | q.s. to |
| Adjusting Agent) | 100% | 100% | 100% | 100% | 100% | 100% | 100% |
| Microefficiency against | | | | | | | |
| Salmonella Enterica | | | | | | | |
| Observed Average | 0.7 | 1.34 | 1.60 | 1.17 | 1.57 | 1.26 | 1.62 |
| Log₁₀ Reduction | | | | | | | |
| Observed Average | 10^{0.7} = | 10^{1.34} = | 10^{1.60} = | 10^{0.17} = | 10^{1.57} = | 10^{1.26} = | 10^{1.62} = |
| Reduction | 5.01 | 21.88 | 39.81 | 14.79 | 37.15 | 18.20 | 41.69 |
| (AntiLog₁₀ value) | | | | | | | |
| Expected Reduction via | — | — | 25.79 | — | 33.43 | — | 36.10 |
| Colby's Calculation | | | | | | | |
| (AntiLog₁₀ value) | | | | | | | |

### Example 18

TABLE 20 showed the synergistic effect between CPC and lactic acid against other microbials beside Salmonella Enterica. The tested microbials were Listeria Monocytogenes, Escherichia coli, and Campylobacter Jejuni. The test antimicrobial compositions contained CPC at 0.8 wt % and lactic acid at 3 wt % based on total weight of the composition. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

TABLE 20

| | #20A | #20B | #20C |
|---|---|---|---|
| CPC | 0.8% | — | 0.8% |
| Lactic acid | — | 3% | 3% |
| Organic Solvent | 1.2% | — | 1.2% |
| Water (including pH adjusting agent) | q.s. to | q.s. to | q.s. to |
| | 100% | 100% | 100% |
| Microefficiency against Listeria | | | |
| Monocytogenes | | | |
| Observed Aver. Log₁₀ Reduction | 0.90 | 1.04 | 1.46 |
| Observed Average Reduction | 10^{0.90} = | 10^{1.04} = | 10^{1.46} = |
| (AntiLog₁₀ value) | 7.94 | 10.96 | 28.84 |
| Expected Reduction (AntiLog₁₀ value) | — | — | 18.03 |
| Microefficiency against Escherichia coli | | | |
| Observed Aver. Log₁₀ Reduction | 0.95 | 1.1 | 1.57 |
| Observed Average Reduction | 10^{0.95} = | 10^{1.1} = | 10^{1.57} = |
| (AntiLog₁₀ value) | 8.91 | 12.59 | 37.15 |
| Expected Reduction (AntiLog₁₀ value) | — | — | 20.38 |
| Microefficiency against Campylobacter | | | |
| Jejuni | | | |
| Observed Aver. Log₁₀ Reduction | 0.80 | 0.80 | 1.65 |
| Observed Average Reduction | 10^{0.80} = | 10^{0.80} = | 10^{1.65} = |
| (AntiLog₁₀ value) | 6.31 | 6.31 | 44.67 |
| Expected Reduction (AntiLog₁₀ value) | — | — | 12.22 |

As shown in TABLE 20 above, Antimicrobial Composition #20C showed a synergistic effect between CPC and lactic acid against the tested microbials: Listeria Monocytogenes, Escherichia coli, and Campylobacter Jejuni.

### Example 19

TABLE 21 showed the antimicrobial efficacy of the antimicrobial compositions against Salmonella Enterica ATCC 10708 to demonstrate the synergistic effect between cetyl pyridinium chloride (CPC) and various peroxycarboxylic acids. The tested peroxycarboxylic acids were percaproic acid, percapric acid, perlauric acid, and perglycolic acid.

The concentration of CPC was 0.80 wt %, and the concentration of tested peroxycarboxylic acid was 0.06 wt % based on total weight of the antimicrobial composition. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

Antimicrobial Composition #21A, which contained CPC as the sole antimicrobial compound, provided an antimicrobial efficacy against Salmonella Enterica at a log₁₀ reduction of 1.07 (i.e., AntiLog₁₀ value of 11.75). Antimicrobial Composition #21B, which contained percaprylic acid as an antimicrobial compound, provided a log₁₀ reduction of 1.30 (i.e., AntiLog₁₀ value of 19.95).

Antimicrobial Composition #21C, which was essentially the combination of Antimicrobial Compositions #21A and #21B, contained both CPC and percaprylic acid as antimicrobial compounds. Antimicrobial Composition #21C provided the antimicrobial efficiency (“Observed Average Log₁₀ Reduction”) at a log₁₀ reduction of 1.56 (i.e., AntiLog₁₀ value of 36.31). The “Observed Average Reduction” of Antimicrobial Composition #16C at the AntiLog₁₀ value of 36.31 was higher than the “Expected Reduction via Colby's Calculation” at the AntiLog₁₀ value of 29.36. Therefore, there was a synergistic effect between CPC and percaprylic acid in Composition #21C.

Furthermore, TABLE 21 showed that there were a synergistic effect between CPC and percapric acid in Antimicrobial Composition #21E, a synergistic effect between CPC and perlauric acid in Antimicrobial Composition #21G, and a synergistic effect between CPC and perglycolic acid in Antimicrobial Composition #21J.

TABLE 21

| | #21A | #21B | #21C | #21D | #21E | #21F | #21G | #21H | #21J |
|---|---|---|---|---|---|---|---|---|---|
| CPC | 0.80% | — | 0.80% | — | 0.80% | — | 0.80% | — | 0.80% |
| Percaprylic acid | — | 0.06% | 0.06% | — | — | — | — | — | — |
| Percapric acid | — | — | — | 0.06% | 0.06% | — | — | — | — |
| Perlauric acid | — | — | — | — | — | 0.06% | 0.06% | — | — |
| Perglycolic acid | — | — | — | — | — | — | — | 0.06% | 0.06% |
| Organic Solvent | 0.77% | — | 0.77% | — | 0.77% | — | 0.77% | — | 0.77% |
| Water (including pH | q.s. to | q.s. to | q.s. to | q.s. to | q.s. to | q.s. to | q.s. to | q.s. to | q.s. to |
| Adjusting Agent) | 100% | 100% | 100% | 100% | 100% | 100% | 100% | 100% | 100% |
| Microefficiency against | | | | | | | | | |
| Salmonella Enterica | | | | | | | | | |
| Observed Aver. | 1.07 | 1.30 | 1.56 | 1.19 | 1.48 | 1.34 | 1.83 | 1.15 | 1.46 |
| Log₁₀ Reduction | | | | | | | | | |
| Observed Average | 10^{1.07} = | 10^{1.30} = | 10^{1.56} = | 10^{1.19} = | 10^{1.48} = | 10^{1.34} = | 10^{1.83} = | 10^{1.15} = | 10^{1.46} = |
| Reduction | 11.75 | 19.95 | 36.31 | 15.49 | 30.20 | 21.87 | 67.61 | 14.13 | 28.84 |
| (AntiLog₁₀ value) | | | | | | | | | |
| Expected Reduction | — | — | 29.36 | — | 25.42 | — | 31.05 | — | 24.22 |
| via Colby's Calculation | | | | | | | | | |
| (AntiLog₁₀ value) | | | | | | | | | |

### Example 20

TABLE 22 demonstrated that anionic surfactant, nonionic surfactant, and/or pH adjusting acid did not contribute to the synergistic effect against Salmonella Enterica ATCC 10708 for the antimicrobial compositions that comprise quaternary ammonium salt and peroxycarboxylic acid.

CPC was used as the quaternary ammonium salt at a concentration of 0.80 wt %, and peracetic acid was used as the peroxycarboxylic acid at a concentration of 0.06 wt % based on total weight of the antimicrobial composition. Sodium octyl sulfonate was used as an anionic surfactant, and alkyl polyglucoside was used as a nonionic surfactant. Propylene glycol was used as an organic solvent to assist in the dispersion and stabilization of CPC in water; wherein propylene glycol by itself did not provide any antimicrobial efficiency. The tested antimicrobial compositions had pH of from about 1.0 to about 4.0, and methane sulfonic acid was used as a pH adjusting acid to achieve the desired pH.

TABLE 22

| | #22A | #22B | #22C | #22D | #22E | #22E |
|---|---|---|---|---|---|---|
| CPC | 0.80% | — | 0.8% | 0.8% | 0.8% | 0.8% |
| Peracetic acid (PAA) | — | 0.06% | 0.06% | 0.06% | 0.06% | 0.06% |
| Anionic Surfactant | — | — | — | 1% | — | — |
| Nonionic Surfactant | — | — | — | — | 0.70% | — |
| pH Adjusting Agent | — | — | — | — | — | YES |
| Organic Solvent | 0.96% | — | 0.96% | 0.96% | 0.96% | 0.96% |
| Water | q.s. to | q.s. to | q.s. to | q.s. to | q.s. to | q.s. to |
| | 100% | 100% | 100% | 100% | 100% | 100% |
| Microefficiency against | | | | | | |
| Salmonella Enterica | | | | | | |
| Observed Average | 0.70 | 1.30 | 1.79 | 1.77 | 1.82 | 1.61 |
| Log₁₀ Reduction | | | | | | |
| Observed Average | 10^{0.70} = | 10^{1.30} = | 10^{1.79} = | | | |
| Reduction | 5.01 | 19.95 | 61.65 | | | |
| (AntiLog₁₀ value) | | | | | | |
| Expected Reduction | — | — | 23.96 | | | |
| via Colby's Calculation | | | | | | |
| (AntiLog₁₀ value) | | | | | | |

Antimicrobial Composition #22C was essentially the combination of Antimicrobial Compositions #22A and #22B, contained both CPC and peracetic acid as antimicrobial compounds. Antimicrobial Composition #22C provided the antimicrobial efficiency (“Observed Average Log₁₀ Reduction”) at a log₁₀ reduction of 1.79 (i.e., AntiLog₁₀ value of 62.65). The “Observed Average Reduction” of Antimicrobial Composition #22C at the AntiLog₁₀ value of 62.65 was significantly higher than the “Expected Reduction via Colby's Calculation” at the AntiLog₁₀ value of 23.96. Therefore, there was a synergistic effect between CPC and peracetic acid in Antimicrobial Composition #22C.

Antimicrobial Composition #22D was Antimicrobial Composition #22C with the presence of anionic surfactant in the composition. Antimicrobial Composition #22E was Antimicrobial Composition #22C with a presence of nonionic surfactant in the composition. Antimicrobial Composition #22E was Antimicrobial Composition #22C with a presence of pH adjusting agent in the composition. As shown in TABLE 22, Antimicrobial Compositions #22D, #22E, and #22F did not showed any improvement in the antimicrobial efficacy. Therefore, anionic surfactant, nonionic surfactant, and/or pH adjusting agent did not contribute to the synergistic effect in the antimicrobial composition.

### Example 21

TABLE 23 showed the antimicrobial efficacy of the antimicrobial compositions against Salmonella Enterica ATCC 10708 to demonstrate the synergistic effect between CPC and peracetic acid in the presence of different anionic surfactants. The tested anionic surfactants were sodium octyl sulfonate (“Sulfonate” surfactant), sodium lauryl sarcosinate (“Sarcosinate” surfactant), and phosphate ester of natural fatty acid (“Phosphate Ester” surfactant).

The concentration of peracetic acid was 0.06 wt %, and the concentration of CPC was 0.8 wt % based on total weight of the antimicrobial composition. Propylene glycol was used as an organic solvent to assist in the dispersion and stabilization of CPC in water. Propylene glycol by itself did not provide any antimicrobial efficiency. Alkyl polyglucoside was used as a nonionic surfactant. The tested antimicrobial compositions had pH of from about 1.0 to about 4.0, and methane sulfonic acid was used as a pH adjusting acid to achieve the desired pH value.

As shown in TABLE 23, there was synergistic effect between CPC and lactic acid regardless the types of anionic surfactants being used in the tested antimicrobial compositions.

TABLE 23

| | #23A | #23B | #23C | #23D | #23E | #23F | #23G |
|---|---|---|---|---|---|---|---|
| Peracetic Acid | 0.06% | — | 0.06% | — | 0.06% | — | 0.06% |
| CPC | — | 0.8% | 0.8% | 0.8% | 0.8% | 0.8% | 0.8% |
| Sulfonate Surfactant | — | 1.00% | 1.00% | — | — | — | — |
| Sarcosinate Surfactant | — | — | — | 0.28% | 0.28% | — | — |
| Phosphate Ester Surfactant | — | — | — | — | — | 1.00% | 1.00% |
| Nonionic Surfactant | — | 0.70% | 0.70% | 0.70% | 0.70% | 0.70% | 0.70% |
| Organic Solvent | — | 0.96% | 0.96% | 0.96% | 0.96% | 0.96% | 0.96% |
| Water (including pH | q.s. to | q.s. to | q.s. to | q.s. to | q.s. to | q.s. to | q.s. to |
| Adjusting Agent) | 100% | 100% | 100% | 100% | 100% | 100% | 100% |
| Microefficiency against | | | | | | | |
| Salmonella Enterica | | | | | | | |
| Observed Average | 1.30 | 0.82 | 1.84 | 1.12 | 1.73 | 1.20 | 1.78 |
| Log₁₀ Reduction | | | | | | | |
| Observed Average | 10^{1.30} = | 10^{0.82} = | 10^{1.60} = | 10^{1.12} = | 10^{1.73} = | 10^{1.20} = | 10^{1.62} = |
| Reduction | 19.95 | 6.61 | 69.18 | 13.18 | 53.70 | 15.85 | 60.26 |
| (AntiLog₁₀ value) | | | | | | | |
| Expected Reduction | — | — | 25.24 | — | 30.50 | — | 32.64 |
| via Colby's Calculation | | | | | | | |
| (AntiLog₁₀ value) | | | | | | | |

### Example 22

TABLE 24 showed the synergistic effect between CPC and peracetic acid against Salmonella Enterica ATCC 10708, at various weight ratios of CPC:peracetic acid in the tested antimicrobial compositions. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

Antimicrobial Compositions #24A to #24G contained CPC at 0.08 wt % and at various weight ratios of CPC:peracetic acid. As shown in TABLE 24, the synergistic effect between CPC and lactic acid at various weight ratios of CPC:peracetic acid.

TABLE 24

| | | | | Microefficiency against | | |
|---|---|---|---|---|---|---|
| | | | | Salmonella Enterica | | |
| | | | Weight | | | Expected |
| | | Amount | Ratio of | Observed | Observed | Reduction via |
| | Amount | of | CPC: | Average | Average | Colby's |
| Antimicrobial | of | Peracetic | Peracetic | Log₁₀ | Reduction | Calculation |
| Composition | CPC | Acid | Acid | Reduction | (AntiLog₁₀ value) | (AntiLog₁₀ value) |
| #24A | 0.08% | — | — | 0.84 | 10^{0.84} = 6.92 | — |
| #24B | — | 0.008% | — | 1.03 | 10^{1.03} = 10.72 | — |
| #24C | 0.08% | 0.008% | 1:0.10 | 1.30 | 10^{1.30} = 19.95 | 16.90 |
| #24D | — | 0.01% | — | 1.10 | 10^{1.10} = 12.58 | — |
| #24E | 0.08% | 0.01% | 1:0.125 | 1.40 | 10^{1.40} = 25.12 | 18.63 |
| #24F | — | 2.00% | — | 1.80 | 10^{1.80} = 63.10 | — |
| #24G | 0.08% | 2.00% | 1:2.50 | 1.95 | 10^{1.95} = 89.13 | 65.65 |

### Example 23

TABLE 25 showed the synergistic effect between CPC and peracetic acid against other microbials beside Salmonella Enterica. The tested microbials were Listeria Monocytogenes, Escherichia coli, and Campylobacter Jejuni.

CPC was used as the quaternary ammonium salt at a concentration of 0.8 wt %, and peracetic acid was used as the peroxycarboxylic acid at a concentration of 0.06 wt % based on total weight of the antimicrobial composition. Propylene glycol was used as an organic solvent to assist in the dispersion and stabilization of CPC in water. Propylene glycol by itself did not provide any antimicrobial efficiency. The tested antimicrobial compositions had pH of from about 1.0 to about 4.0, and methane sulfonic acid was used as a pH adjusting acid to achieve the desired pH value.

TABLE 25

| | #25A | #25B | #25C |
|---|---|---|---|
| CPC | 0.86% | — | 0.86% |
| Peracetic Acid (PAA) | — | 0.06% | 0.06% |
| Organic Solvent | 0.96% | — | 0.96% |
| Water (including pH adjusting agent) | q.s. to | q.s. to | q.s. to |
| | 100% | 100% | 100% |
| Microefficiency against Listeria | | | |
| Monocytogenes | | | |
| Observed Aver. Log₁₀ Reduction | 1.05 | 1.40 | 1.66 |
| Observed Average Reduction | 10^{1.05} = | 10^{1.40} = | 10^{1.66} = |
| (AntiLog₁₀ value) | 11.22 | 25.12 | 45.71 |
| Expected Reduction (AntiLog₁₀ value) | — | — | 33.52 |
| Microefficiency against Escherichia coli | | | |
| Observed Aver. Log₁₀ Reduction | 1.01 | 1.34 | 1.83 |
| Observed Average Reduction | 10^{1.01} = | 10^{1.34} = | 10^{1.83} = |
| (AntiLog₁₀ value) | 10.23 | 21.88 | 67.61 |
| Expected Reduction (AntiLog₁₀ value) | — | — | 29.87 |
| Microefficiency against Campylobacter | | | |
| Jejuni | | | |
| Observed Aver. Log₁₀ Reduction | 0.99 | 1.10 | 1.58 |
| Observed Average Reduction | 10^{0.99} = | 10^{1.10} = | 10^{1.58} = |
| (AntiLog₁₀ value) | 9.77 | 12.59 | 38.02 |
| Expected Reduction (AntiLog₁₀ value) | — | — | 21.13 |

As shown in TABLE 25 above, Antimicrobial Composition #25C showed a synergistic effect between CPC and lactic acid against the tested microbials: Listeria Monocytogenes, Escherichia coli, and Campylobacter Jejuni.

### Example 24

Chicken drumettes (without inoculation) were treated with the tested antimicrobial composition for 30 seconds, and then allowed to drip for 1 minute on sterile racks. Then, the neutralization was performed by putting the chicken drumettes in neutralizer bags containing 100 ml nBPW and placed the bags in an orbital shaker for 5 minutes at 150 RPM. After the neutralization, the chicken drumettes were removed from the neutralizer bags. To the 100 ml of nBPW solution remained in the neutralizer bags, 1 ml culture of Salmonella enterica ATCC 10708 (approximately 6×10⁸ cfu/ml) was added. As such, the amount of Salmonella enterica ATCC 10708 in the neutralizer bags was approximately 6×10⁶ cfu/ml (i.e., 100 times dilution of the culture). After 5 minutes, 1 ml of the liquid in neutralizer bags was taken for enumeration by serial dilution plate technique.

If the tested antimicrobial composition was completely neutralized, the pathogen culture count would remained unchanged (i.e., approximately 6×10⁶ cfu/ml). If the tested antimicrobial composition was not completely neutralized, it would continue its antimicrobial activity against Salmonella enterica ATCC 10708, resulting in a reduction of the pathogen culture count (i.e., lower than approximately 6×10⁶ cfu/ml).

Three antimicrobial compositions were tested for the validation of neutralization: Antimicrobial Composition #26C was prepared and tested for the synergistic effect between peracetic acid and formic acid as shown in TABLE 26. Antimicrobial Composition #27C was prepared and tested for the synergistic effect between CPC and malic acid as shown in TABLE 27. Antimicrobial Composition #28C was prepared and tested for the synergistic effect between peracetic acid and CPC as shown in TABLE 28. Alkyl polyglucoside was used as a nonionic surfactant, and sodium lauryl sulfate was used as an anionic surfactant. Propylene glycol was used as an organic solvent to assist in the dispersion and stabilization of CPC in water. Propylene glycol by itself did not provide any antimicrobial efficiency. Alkyl polyglucoside was used as a nonionic surfactant. The tested antimicrobial compositions had pH of from about 1.0 to about 4.0, and methane sulfonic acid was used as a pH adjusting acid to achieve the desired pH value.

TABLE 26

| | #26A | #26B | #26C |
|---|---|---|---|
| Peracetic Acid (PAA) | 0.025% | — | 0.025% |
| Formic Acid | — | 2.55% | 2.55% |
| Anionic Surfactant | — | 0.28% | 0.28% |
| Nonionic Surfactant | — | 0.50% | 0.50% |
| Water (including pH adjusting agent) | q.s. to | q.s. to | q.s. to |
| | 100% | 100% | 100% |
| Microefficiency against Salmonella | | | |
| Enterica | | | |
| Observed Average Log₁₀ Reduction | 1.16 | 1.74 | 2.16 |
| Observed Average Reduction | 10^{1.16} = | 10^{1.74} = | 10^{2.16} = |
| (AntiLog₁₀ value) | 14.45 | 54.95 | 144.54 |
| Expected Reduction via Colby's | — | — | 61.46 |
| Calculation (AntiLog₁₀ value) | | | |

TABLE 27

| | #27A | #27B | #27C |
|---|---|---|---|
| CPC | 0.08% | — | 0.08% |
| Malic Acid | — | 3.00% | 3.00% |
| Organic Solvent | 1.20% | — | 1.20% |
| Water (including pH adjusting agent) | q.s. to | q.s. to | q.s. to |
| | 100% | 100% | 100% |
| Microefficiency against Salmonella Enterica | | | |
| Observed Average Log₁₀ Reduction | 0.74 | 0.87 | 1.40 |
| Observed Average Reduction | 10^{0.74} = | 10^{0.87} = | 10^{1.40} = |
| (AntiLog₁₀ value) | 5.50 | 7.41 | 25.12 |
| Expected Reduction via Colby's Calculation | — | — | 12.50 |
| (AntiLog₁₀ value) | | | |

TABLE 28

| | #28A | #28B | #28C |
|---|---|---|---|
| CPC | 0.80% | — | 0.80% |
| Peracetic Acid | — | 0.06% | 0.06% |
| Organic Solvent | 1.20% | — | 1.20% |
| Nonionic Surfactant | — | 0.50% | 0.50% |
| Water (including pH adjusting agent) | q.s. to | q.s. to | q.s. to |
| | 100% | 100% | 100% |
| Microefficiency against Salmonella Enterica | | | |
| Observed Average Log₁₀ Reduction | 0.74 | 1.46 | 1.87 |
| Observed Average Reduction | 10^{0.74} = | 10^{1.46} = | 10^{1.87} = |
| (AntiLog₁₀ value) | 5.50 | 28.84 | 74.13 |
| Expected Reduction via Colby's Calculation | — | — | 32.75 |
| (AntiLog₁₀ value) | | | |

TABLE 29 showed the counts of culture Salmonella Enterica ATCC 10708 after neutralization step.

TABLE 29

| | Counts of culture Salmonella Enterica |
|---|---|
| Antimicrobial Composition | after neutralization step (cfu/ml) |
| #26C | 6 × 10⁶ |
| #27C | 6 × 10⁶ |
| #28C | 6 × 10⁶ |

Antimicrobial Compositions #26C, #27C and #28C, each provided the culture counts after neutralization step of approximately 6×10⁶ cfu/ml. This indicated that each of the tested antimicrobial compositions was neutralized completely with the nBPW neutralizer, without any carry over after neutralization.

Various features and advantages of the invention are set forth in the following claims.

1. A synergistic antimicrobial composition, comprising:
a peroxycarboxylic acid in an amount of from about 0.006 wt % to about 0.20 wt % based on total weight of the composition;
a carboxylic acid in an amount of from about 0.008 wt % to about 10 wt % based on total weight of the composition;
an anionic surfactant;
water,
wherein the antimicrobial composition has a pH no more than 7.

2. The antimicrobial composition of claim 1, wherein the peroxycarboxylic acid is present in an amount of from about 0.01 wt % to about 0.20 wt % based on total weight of the composition.

3. The antimicrobial composition of claim 1, wherein the peroxycarboxylic acid comprises performic acid, peracetic acid, peroxypentanoic acid, peroxyhexanoic acid, peroxyheptanoic acid, peroxyoctanoic acid, peroxynonanoic acid, peroxydecanoic acid, peroxyundecanoic acid, peroxydodecanoic acid, perglycolic acid, peroxyascorbic acid, peroxyadipic acid, peroxycitric acid, peroxypimelic acid, peroxysuberic acid, or any mixture thereof.

4. The antimicrobial composition of a claim 2, wherein the peroxycarboxylic acid comprises performic acid, peracetic acid, peroxyoctanoic acid, peroxydecanoic acid, peroxydodecanoic acid, perglycolic acid, or any mixture thereof.

5. The antimicrobial composition of claim 1, wherein the carboxylic acid is present in an amount of from about 0.015 wt % to about 10 wt %.

6. (canceled)

7. The antimicrobial composition of claim 1, wherein the carboxylic acid comprises formic acid, acetic acid, propionic acid, valeric acid, caproic acid, caprylic acid, nonanoic acid, decanoic acid, undecanoic acid, lauric acid, cinnamic acid, benzoic acid, or any mixture thereof.

8. The antimicrobial composition of claim 1, wherein the carboxylic acid comprises succinic acid, adipic acid, itaconic acid, oxalic acid, fumaric acid, aconitic acid, pimelic acid, suberic acid, or any mixture thereof.

9. The antimicrobial composition of claim 1, wherein the carboxylic acid fulfills at least one of the following:
(a) the carbocylic acid comprises hydroxy group;
(b) the carboxylic acid has a number of carbon atoms in a range of from one carbon atom to 20 carbon atoms.

10. The antimicrobial composition of claim 1, wherein the carboxylic acid comprises glycolic acid, lactic acid, citric acid, gluconic acid, malic acid, salicylic acid, tartartic acid, ascorbic acid, erythorbic acid, arginic acid, mandelic acid, or any mixture thereof.

11. The antimicrobial composition of claim 1, wherein the anionic surfactant is present in an amount of from about 0.001 wt % to about 1.1 wt %.

12. The antimicrobial composition of claim 1, wherein the anionic surfactant comprises sulfate-based surfactant, sulfonate-based surfactant, sarcosinate-based surfactant, sulfosuccinate-based surfactant, carboxylate-based surfactant, phosphate ester-based surfactant, or any mixture thereof.

13. The antimicrobial composition of 12, wherein the anionic surfactant fulfills at least one of the following:
(a) the sulfate-based surfactant comprises alkyl sulfate, alkyl ether sulfate, alkyl ethoxysulfate, fatty oleyl glycerol sulfate, alkyl phenol ethylene oxide ether sulfate, glucamine sulfate, or any combination thereof,
(b) the sulfonate-based surfactant comprises sodium octyl sulfonate, C5-C20 alkyl benzenesulfonic acid, C5-C20 alkyl benzenesulfonate, olefin sulfonate, or any combination thereof,
(c) the sarcosinate-based surfactant comprises sodium myristoyl sarcosinate, sodium lauroyl sarcosinate, sodium oleoyl sarcosinate, sodium cocoyl sarcosinate, or any combination thereof,
(d) the sulfosuccinate-based surfactant comprises sodium dioctyl sulfosuccinate, sodium monododecyl sulfosuccinate, sodium bis(2-ethylhexyl) sulfosuccinate, disodium laureth sulfosuccinate, or any combination thereof,
(e) the carboxylate-based surfactant comprises carboxylate salt, ester carboxylic salt, ether carboxylic salt, or any combination thereof,
(f) the phosphate ester-based surfactant comprises phosphate ester of natural fatty acid, phosphate ester of ethoxylated alcohol, phosphate ester of alkyl phenol ethoxylate, phosphate ester of polyoxyethylenated alkylphenol, or any mixture thereof.

14. The antimicrobial composition of claim 1, wherein the anionic surfactant comprises alkyl sulfonate, alkylaryl sulfonate, alkylated diphenyl oxide disulfonate, alkylated naphthalene sulfonate, alcohol alkoxylate carboxylate, sarcosinate, taurate, acyl amino acid, alkanoic ester, phosphate ester, sulfuric acid ester, salt or acid form thereof, or any mixture thereof.

15. The antimicrobial composition of claim 1, wherein the anionic surfactant comprises sodium lauryl sulfate, sodium octyl sulfonate, sodium lauroyl sarcosinate, sodium octyl sulfosuccinate, capryleth-9-carboxylic acid, phosphate ester of natural fatty acid, alkyl sulfonic acid, alkyl aryl sulfonic acid, or any mixture thereof.

16. The antimicrobial composition of claim 1, wherein the antimicrobial composition further comprises a nonionic surfactant, a pH adjusting acid, or a combination thereof.

17. The antimicrobial composition of claim 16, wherein the nonionic surfactant fulfills at least one of the following:
(a) the nonionic surfactant is present in an amount of from about 0.003% to 2.8 wt %, preferably from about to about 0.02 wt % to about 2 wt % based on total weight of the composition;
(b) the nonionic surfactant comprises alkyl polyglucoside, alcohol alkoxylate surfactants, alkoxylated surfactants, sorbitan surfactants, fatty acid ester surfactants, fatty alcohol surfactants, amine oxide surfactants, or any mixture thereof;
(c) the nonionic surfactant comprises alkyl poly glucoside (C8-C10), coco poly glucoside (C8-C16), lauryl poly glucoside (C12-C16), or any mixture thereof.

18.-20. (canceled)

21. The antimicrobial composition of claim 16, wherein the pH adjusting acid fulfills at least one of the following:
(a) the pH adjusting acid comprises sulfuric acid, alkyl sulfonic acid, alkyl aryl sulfonic acid, aryl sulfonic acid, or any mixture thereof;
(b) the pH adjusting acid comprises methane sulfonic acid, sulfuric acid, p-toluene sulfonic acid, benzene sulfonic acid, or any mixture thereof.

22. (canceled)

23. The antimicrobial composition of claim 1, wherein a weight ratio of the peroxycarboxylic acid:the carboxylic acid is from about 0.005:1 to about 4:1.

24. The antimicrobial composition of claim 1, wherein the antimicrobial composition comprises, based on total weight of the composition:
from about 0.01 wt % and to 0.2 wt % of the peroxycarboxylic acid;
from about 0.01 wt % to about 10 wt % of the carboxylic acid;
from about 0.02 wt % to about 1 wt % of the anionic surfactant; and
water.

25. A method of reducing microbial contaminants during poultry processing, comprising: contacting a surface of the poultry, a surface of equipment used in processing the poultry, or both with the synergistic antimicrobial composition of claim 1, during processing the poultry.

26.-75. (canceled)
